(19) United States
(12) Patent Application Publication
(10) Pub. No.: US 2003/0149496 A1
(43) Pub. Date: Aug. 7, 2003

(54) Portable electronic information collection and presentation device

(76) Inventor: William L. Johnson, Parker, CO (US)

Correspondence Address: KYLE W. ROST, 5490 AUTUMN CT., GREENWOOD VILLAGE, CO, 80111, US

(21) Appl. No.: 10/345,534

(22) Filed: Jan. 16, 2003

Related U.S. Application Data
(60) Provisional application No. 60/350,280, filed on Jan. 17, 2002.

(51) Int. Cl. G06F 17/00

(52) U.S. Cl. 700/91

(57) ABSTRACT

A golfer's electronic assistant device (10) provides a touch screen (18) on a core module (12) with removable side modules (14, 16) powering the core module (12) and supplying functional expansions. A modular dock (50) in the core module receives essential equipment modules such as a global positioning system. The touch screen (18) shows graphical representations of each golf hole, the golfer's present position, and accurate distances to the pin, fairway hazards, and landmarks. Each round is timed, and data for scoring and other statistics is entered, stored in a database, and analyzed to produce an output of data personalized to the golfer's characteristics. The output may provide current golf handicap, and situational tips such as a recommended club selection for any situation based on prior performance, global positioning data, and total score.

### CROSS-REFERENCE TO RELATED APPLICATIONS

This application claims the benefit of U.S. Provisional Patent Application Serial No. 60/350,280, filed Jan. 17, 2002, pending.

### BACKGROUND OF INVENTION

1. Field of the Invention

The invention generally relates games using a tangible projectile. More specifically, at least in one embodiment the invention relates to golf and to an aid for club selection, ball direction or distance indicating. In a more general field, the invention relates to a personalized scoring, statistics collecting, and distancing system. Both a hardware device and software programmed system may embody the system. Such a device is designed, constructed and programmed to suit the requirements and needs of one or more sports or other specific applications. One such device is designed and engineered to significantly enhance the golfing experience, dramatically improve the golfer's game, and facilitate improved course operations. The system is designed as a personal tool for a golfer. It provides a global positioning system (GPS) for distance technology to significantly enhance the golfer's game. The device contains a wide range of graphical, scoring, and statistical collection features, making it a versatile tool for every level of golfer, from the novice to the professional.

2. Description of Related Art Including Information Disclosed under 37 CFR 1.97 and 1.98

Public interest in sports such as golf and baseball are growing. Participants seek to improve their skills but often do not have suitable help to assist their efforts. Golf, baseball and softball stand out as sports that are heavily dependent on statistics, analysis of the statistics, and reporting of statistics to both play and improve game performance. There is a growing need for a portable electronic information collection and presentation device, with initial focus on sports such as golf, baseball and softball.

Several known devices or software programs can serve as an electronic assistant to a golfer. One of these is Intelligolf, a non-GPS capable software package. Intelligolf requires the associated ownership of a PDA device. The software is helpful in keeping track of scoring and statistics, and the cost is low if a PDA device is already owned. However, using a PDA device on a golf course is labor intensive, and the PDA has no GPS function.

Another is SkyGolfgps, a GPS capable product to be used in conjunction with a personal digital assistant (PDA) device such as those sold under the trademarks Palm Pilot and Visor. SkyGolfgps is helpful in tracking scoring and statistics. However, Skygolfgps and its associated PDA require significant user interaction on the golf course.

Still another is ParView, a fixed GPS system provided at some upscale golf courses around the United States. The ParView system provides robust GPS information to the golfer during play. However, it is a device that is permanently mounted to the golf carts and is only available if the golf course has chosen to install it. The system requires network connectivity support from the golf course.

A product sold under the trademark APROch Golf offers small size, PC synchronization, game analysis and suggested practice drills. However, this device is complex to use, provides no graphics and has no GPS capability.

A product sold under the trademark Bushnell Yardage Pro 600 is small and weather resistant. However, it provides no GPS, no scoring, and no statistics.

A product sold under the trademark LIT Yardage 500 Pro is small and weather resistant. However, it provides no GPS, no scoring, and no statistics.

Several patents show data gathering systems that aid a golfer. U.S. Pat. No. 5,882,269 to Lewis shows a golf practice aid that displays a diagram of a typical golf hole and allows the user to record his shot pattern while making practice shots. The practice aid provides statistical analysis of the shot pattern that allows the user to identify and attempt to correct errors in his shots. In addition, the practice aid can offer basic golfing tips. This practice aid may be applied to a PDA.

U.S. Pat. No. 6,062,991 to Moriarty et al. shows a computerized system that must be installed at fixed stations throughout a golf course to provide a wide variety of information to players and to management. Parts of the system keep score, transfer personal messages, advise on weather, make available the rules of play, and monitor flow of play.

U.S. Pat. No. 6,456,938 to Barnard shows a PDA or hand-held computer linked to a GPS system such that the player can map a golf course by traversing its attributes and collect golf play data. Maps can be shared via an Internet web site.

U.S. Pat. No. 6,461,245 to Morgan shows a golf improvement system consisting of a card including par and distance information about each hole, and a scorecard. The player's information is entered at the clubhouse into the club's computerized database, which generates information about the player's skills.

As applied to the game of golf, it would be desirable to have available an information collection and presentation device that is designed to benefit both the individual golfer as well as the golf course. An electronic assistant device can be a necessity for every golfer, whether serious or casual. By providing immediate access to yardage, through integrated GPS capability, scoring, and playing tips at the touch of a finger, the device will increase the speed of play on the course and will give the golfer the tools necessary to achieve a lower score. The device will automatically provide the golfer critical information, including but not limited to yardage to greens and other course markers, graphical views of course layout, club selection recommendations, and statistics such as gross and net score, average distance for each club, actual distance of each club on each hole during a particular round, number of putts, saves, ups/downs, sand saves, handicaps, etc. The onboard GPS receiver will translate the golfer's exact location into distances from the green and other course markers. Such information is important for every stroke. Individual course information can be available from a public or private database, such as a web site and can be downloaded directly into the portable unit.

In order to best meet the needs of a golfer, an integrated solution should be specific in its design for use with golf. A desirable device would be of a suitable size generally larger than the generally available PDA devices, yet still small enough to hand carry, mount on the cart or bag, or place in the golf bag. The device should require no external support. It would be desirable to need neither a PDA device nor support from the golf course, so that the device is a totally self contained, integrated solution. Such a device should offer a design and construction that is both rugged and weather resistant to withstand the rigors of the golf environment. Other helpful features include a color display that is clear and readable even in direct sunlight. A touch screen preferably should be larger than those commonly found on PDAs so that the golfer gets more information on a single screen and no stylus is required.

Similarly, it would be desirable to provide the combination of portability and hands free operation. A portable device should be useable at any location, while the characteristic of hands free operation is achieved when the device is mountable on both golf carts and golf bags, allowing the golfer to position the device in the most convenient location. The golfer should not have to hold the device to input or retrieve information.

The ability to use dynamic graphics would be highly useful. Course graphics can be supplied from many sources, including as a download from an Internet web site. In addition, the golfer may modify or customize the course graphics however desired.

Further beneficial features include course management, expandability, and ability to serve as a learning aid. A built-in timer can give the golfer constant updates on elapsed time after each hole. This will help the golfer determine whether to pick up the pace of play. Because additional features may be devised, an electronic assistant should be able to receive modifications and enhancements. Yet, it would be desirable to add features without requiring an external PDA-like device or requiring support from the golf course. As a learning aid, an electronic assistant should be capable of learning the golfer's game as he plays and giving valuable tips on the course.

To achieve the foregoing and other objects and in accordance with the purpose of the present invention, as embodied and broadly described herein, the method and apparatus of this invention may comprise the following.

### SUMMARY OF INVENTION

Against the described background, it is therefore a general object of the invention to provide an electronic assistant for use by a participant in a sport. According to a presently preferred embodiment, an electronic assistant for golfers provides intelligent information collection and display capability that can be utilized during play of the sport. This device should be easy to use, compact in size, and have the ability to speed up play.

A more specific object is to provide is a hand held, light-weight, GPS (Global Positioning System) capable, easy to use touch screen device that automatically scores a round of golf while simultaneously collecting statistics on each player, providing immediate feedback regarding club selection and tips as well as distances (yardage) to the green, hazards and other markers on the course.

An objective of the device is to give the golfer a tool that is intuitively easy to use scoring and collecting statistics. The tool should be no more complicated than using a paper scorecard. Yet, it should give the golfer information helpful to improve the golfer's game. Using this tool should not distract the golfer during play and ultimately should speed up play on the course.

Another object is to provide an electronic assistant that learns the golfer's game as it is used. Once a golfer plays one round with the device, the device offers tips on club selection based on the golfer's location and the distance to the green or other markers on the course. The device has audio recording and playback capability, giving the golfer immediate access to on-the-course tips.

A further object is to provide an electronic assistant having a screen large enough to display a substantial amount of useful and allowing use of a finger, rather than a stylus, to manipulate the screen functions. The use of a finger rather than a stylus is important to the easy use of the device, allowing it to be used as easily as a scorecard. Yet, the device should remain small enough and lightweight enough to be carried or stored in a golf bag. The device should be sized to allow mounting to the golf cart or a pull cart, or it should permit being strapped to the golf bag for easy access during play.

Another object is to provide a suitably rugged electronic assistant type of device for a golfer. It should be weather resistant, with an easy to use touch screen graphical user interface. Conforming such a device to the requirements of golf course usage makes it a useable tool that will speed up play rather than slow down or distract the golfer. By such specific contouring to the needs of a golfer while on the golf course, the golfing device can simultaneously score a round, calculate the players' handicap, and collect statistics that can be analyzed for a personalized training program.

Still another object is to provide a personalized and self-contained device. There is no dependency on the golf course to provide any resources. The onboard GPS capability enables the golfer to take the device to any course in the world and begin using it immediately.

Another object is to provide an ability to assist the golfer in designing an individual training program. A desktop software package that interfaces with the device gives the golfer a full range of reports that can be used to design an individual training program.

Additional optional objects are to enable the electronic assistant to gain new capabilities within the existing design. For example, video recording and playback capability can be added as auxiliary modules, providing immediate practice feedback for the driving range. The device can provide a personalized evaluation of the golfer's game based on his actual set of comprehensive statistics, to include hints and tips to improve the weak areas.

Generally, the invention is a portable, computerized personal electronic assistant for aiding a participant engaged in a preselected competitive event employing variably selectable event equipment, including at least a tangible projectile, and conducted in a defined event area. The electronic assistant contains a database storing historical data about marker positions in the defined event area, about a participant involved in the event, about variably selectable event equipment, and about prior results achieved with selected items of event equipment. In addition, it contains a global positioning system device providing real time positional data to the database. A graphic display shows a graphical representation of the defined event area in response to the historical and real time data in said database. The display includes distancing information between a participant and various marker positions. The electronic assistant includes input devices for entering statistics into the database, relating to a participant's selection and use of the variably selectable event equipment. The electronic assistant has the ability to analyze data and provide real time event conduct tips derived from information in the database and from real time positional data. The event conduct tips are may range from event equipment selection tips, tactics tips, and combinations of there.

The invention also is a structure for the electronic assistant, which may include a core module carrying a display screen with a touch screen graphical user interface. This display shows various graphical data according to programmed software. The core module has engagement portions at each of two end walls, and it includes an internal expansion dock for receiving and communicating with an auxiliary device. At least two expansion modules are selectively attachable and removable from the engagement portions of the core module. At least a first one of the expansion modules is a battery pack for powering the core module.

A second one of the expansion modules may have a further function, such as a battery, a digital camera, a medical vital-signs module, a package scanner, a two-way radio, an automotive computer bus interface, or a combination of these. If the second expansion module is a second battery pack, it enables the core module to operate continuously in portable mode by alternating first and second expansion modules. The global positioning system device may be a module connected to the internal expansion dock of the core module.

The personal electronic assistant can be specifically applied to the game of golf for displaying the geographic characteristics of each golf hole. In this instance, the electronic assistant monitors the selection and use of different golf clubs used by a player, as well as positional data in the database of pre-defined markers on a golf hole. The GPS module provides real time distancing information from a participant's location to a pre-defined marker. To address the specific needs of golf, programmed instructions may provide a process flow on the graphic display, allowing selections to: initiate new round of golf; acquire geographic data for a golf hole; maintain a scorecard for the round of golf; record available golf clubs for a player; monitor the player's performance with each of the clubs; and recommend club selection for the player's current shot based upon the geographic data and the player's performance data with each club.

The programmed instructions to initiate a new round of golf may include steps of: selecting initiation of new round; selecting golf course; selecting players; selecting tees for each player; establishing a scorecard; recording a date for each hole as played; and displaying a scorecard when finished.

The programmed instructions to input geographic data for the golf course hole may include steps of selecting entry of golf course data from the group consisting of a previously entered golf course or a non-previously entered golf course. For a non-previously entered golf course, the steps include entering tee names, tee ratings, and tee slopes. Instructions further include selecting yardage options from the group consisting of recording GPS markers during play, entering hole yardage during play, and entering hole yardage before play.

Programmed instructions to select players for a new round of golf further include: maintaining a historical identification of each of a plurality of players; maintaining a historical handicap record for each of the plurality of players; displaying an editable, default list of each of the plurality of player's golf clubs; selecting a player from the plurality of players for edit of the historical record; and entering the selected player on a scorecard record.

The electronic assistant contains a formulas database that enables calculation of benchmarks from the content of said database.

An audio output device is operatively connected to electronic assistant for aurally alerting a participant to the availability of a real time tip.

According to the invention as specifically applied to the game of golf, an electronic assistant for golfers is programmed to provide a process flow according to the following scheme, referring in capital letters to soft buttons and menu choices that are made available on a touch screen:

NEW ROUND

Select course or specify a new course (COURSES)

If new course, then go to NEW COURSE

Select players or specify new players (PLAYERS)

If new player, go to NEW PLAYER

Select tees for each player (SELECT PLAYER'S TEES)

Display scorecard, the when finished, select PLAY

HOLE 1, HOLE 2, HOLE 3, etc.

Display scorecard when finished with HOLE 18, or select DONE to quit round

COURSES

NEW COURSE

Record new course information

NEW COURSE 1 (General Information)

NEW COURSE 2 (Tee names)

NEW COURSE 3 (Tee ratings/slopes)

YARDAGE OPTIONS

Record GPS markers during play

Enter hole yardage during play

Enter hole yardage before play

NEW COURSE YARDAGE

NEW COURSE YARDAGE FOR TEES

PAR FOR THIS COURSE

SCORECARD

Display scorecard for highlighted course

OK

Select highlighted course: If selected to play, then select; if selected from

COURSES, then display course information and allow for edit.

BACK

Return to previous menu

PLAYERS

NEW PLAYER

Enter player first name

Enter player last name

Enter player handicap, if known . . . else system will compute once enough rounds have been played.

PLAYER'S CLUBS

Display the following list of clubs: 1 W, 2W, 3 W, 4W, 5W, 7W, 9W, 1, 2, 3, 4, 5, 6, 7, 8, 9, PW, UW, SW, LW, P. The clubs in red should be highlighted to indicate defaults.

OK

Select highlighted player. If selected to play, select player; if selected from PLAYERS, then display player information for edit.

BACK

Return to previous menu

CONTINUE

Display all rounds less than 18 holes . . . show Course Name and Date

Allow player to select round to continue

HANDICAP

For each player, show list of all rounds contained in the system.

Allow user to select all rounds to be included in calculation of handicap, or select specific rounds to be included (see functional concept screens)

STATISTICS

For each player, show list of all rounds contained in the system.

Allow user to select all rounds to be included in calculation of statistics, or select specific rounds to be included (see functional concept screens)

Display General Statistics and Performance Statistics (see functional concept screens)

REPORTS

Statistical Report by player

Scorecard for specific round

Training Program by player

Playing Tips by selected topic

UPLOAD/DOWNLOAD

Provide screens to step user through synching hand device with PC database to allow for: software upgrades, course descriptions, etc.

The accompanying drawings, which are incorporated in and form a part of the specification, illustrate preferred embodiments of the present invention, and together with the description, serve to explain the principles of the invention. In the drawings:

### BRIEF DESCRIPTION OF DRAWINGS

FIG. 1 is an exploded view of the electronic assistant taken from a right front top position, showing the hardware components of an electronic assistant device.

FIG. 2 is an isometric view of the electronic assistant, taken from a right front top position.

FIG. 3 is an isometric view of the electronic assistant, taken from a left rear bottom position.

### DETAILED DESCRIPTION

A portable electronic information collection and presentation device and system provides a variety of graphical, scoring, and statistical collection features relating to conduct of a competition, sport, or game. The device is especially well adapted to assist in conduct of a competition or play of a game that uses a tangible projectile in a defined area, such that knowledge of the participant's exact position or the exact position of the projectile is useful. Similarly, the device is well adapted to assist in conduct of a competition or play of a game that uses a variable selection of equipment, such that advice on which equipment to select in a particular situation is useful.

For purposes of example and not limitation, this device will be described as it may be specifically constructed or software programmed to accommodate the game of golf. As well known, golf is played over defined areas known as golf courses, including sub-areas known as the individual holes of the course. Selected game play equipment may include the individual selection of golf clubs used by a player, as well as the selection of golf balls, perhaps differentiated by brand. The golf ball also constitutes the projectile. In the specific application of golf, the device will be referred to as a golfing electronic assistant, device, or system. Additional references will show available adaptation to the games of baseball and softball. For that application, the device will be referred to as a baseball electronic assistant, device, or system. These examples will illustrate structures, hardware, software, methods and processes that enable the device to similarly accommodate other sports or games and other non-sporting applications.

This information device may collect, analyze and present data derived from the ambient surroundings of an event or activity, from the people involved in an activity, and from equipment used in an activity. On important type of information in many sports or other activities is the graphical overview. Many activities benefit when exact distances from one part of an area to another are known. For example, irregularities in nearby geography may be significant. Early identification of hazards and landmarks may benefit a participant. An elapsed timer can monitor the pace of an event. As a participant moves to different physical areas during an activity, the system displays the participant's position in relation to defined markers in the immediate area. The device may be pre-loaded with information about local markers. Such information may be obtained from any source of local data. An Internet web site, a guidebook or map, or other source can provide advance information.

The device's versatility enables the user to dynamically build a customized graphical representation of the area in real time. Exact distancing is available by using global positioning system (GPS) technology. An electronic assistant device can provide distancing from the user's current location to every pre-defined marker in the area, allowing user to view the distance covered during any part of an event, distance remaining to the front, back, left, right, and center of an area, or distance to a next marker or hazard. The device can be used for electronic scoring and as a statistics collection system. The electronic scoring and statistics collection features of the device require very little interaction from the user. Most is done automatically at the simple touch of a finger. The device can score and collect statistics for a plurality of participants per event. A graphics display shows progress of an event and substantially any desired statistical analysis of the event on a real time basis. These features automatically show current scores and display the current scoring totals and statistics as an event progresses. The information collected by the device can be taken home to prepare statistical and game analysis reports that facilitate the development of a personal training program to improve the user's performance. The device provides intelligent tips on how to better perform during an event. Combining the unique GPS and comprehensive statistical collection features, the device learns the user's methods of performing. As the user prepares to perform any part of a sport or other activity, the device gives helpful hints on equipment selection or choice of tactics based on historical statistical information. This feature is automatically provided for every participant in the device's database.

The device is ergonomically engineered and designed specifically to improve the user's game and speed up play of a game while allowing users to score their activities at “the-touch-of-a-finger”. The device is both fun and easy to use, and the device's small size as well as its weather resistant and rugged design provides users with a tool specifically suited for the rigors of the golf course or practice tee.

With reference to the drawings, the electronic assistant device 10 has been developed to have a versatile core module 12 consisting of an enclosure containing a programmable processor and various electronic components and circuitry to allow the processor to calculate and display an output on the touch screen. Selected expansion modules 14 and 16 are attached and removably carried on the opposite lateral sides of the core module. Allowing one or more vacant locations with connecting and docking interfaces inside the unit 12 achieve further hardware expansion capability. This gives the device 10 an ability to contain and incorporate additional technology, serve additional industries, games, competitions, or sports, or better serve existing industries or sports without months of redesign, re-engineering, and costly re-tooling. Thus, as the device 10 is applied to golf, the core module 12 contains computing capacity and versatility far exceeding personal data assistants and comparable with many of today's entry model laptop computers. Future enhancements to the golf device 10 as well as technology upgrades for future sports or markets will take several months of additional engineering rather than the nearly two years required for the initial product.

The hardware components of the device 10 may include certain standard components that can be used with more than one application. A key feature is the active touch screen 18 on the front face of the core module 12. This screen can display various graphical data according to programmed software. Often the data will be menus driven by software that creates finger touch buttons. Thus, the display 18 allows the device 10 to provide a software-selected variety of functions.

On the top face of the device, a series of controls may operate the hardware and software. A POWER switch 20 controls on/off functions. A backlight control 22 is useful for adjusting the viewing properties of the touch screen. Various communications ports and jacks may be located in a top compartment 24. For example, this compartment may house such known components as a USB port, audio in and audio out jacks, and an external microphone jack. The core module 12 contains audio recording and playback means, which are controlled by a RECORD control 26, a STOP control 28, a PLAY control 30, a FORWARD control 32, and a REVERSE control 34. An optional control button 36 provides expansion capability and may be under hardware or software control. An internal microphone 38 is present, and a RECORD light 40 shows that recording is active. The top face also may carry an infrared window 42, allowing infrared data communications with external devices such as a desktop computer.

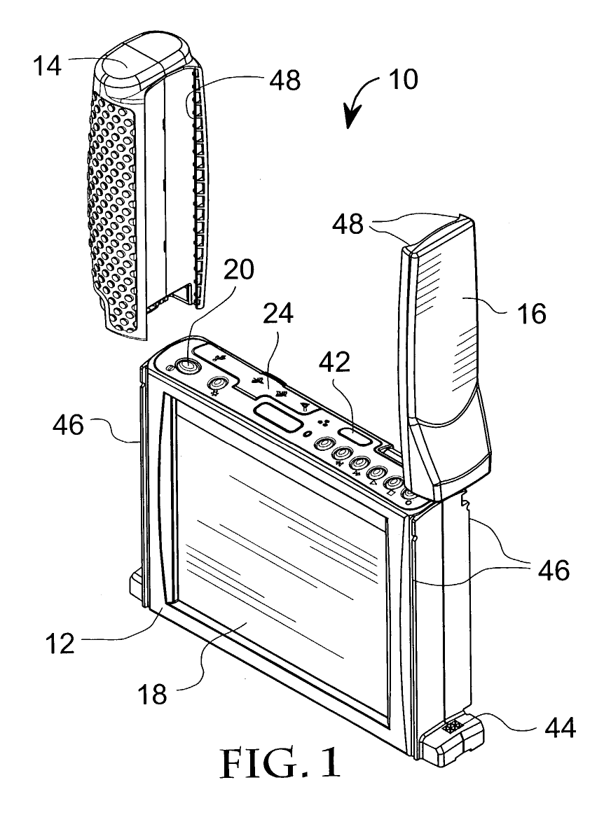

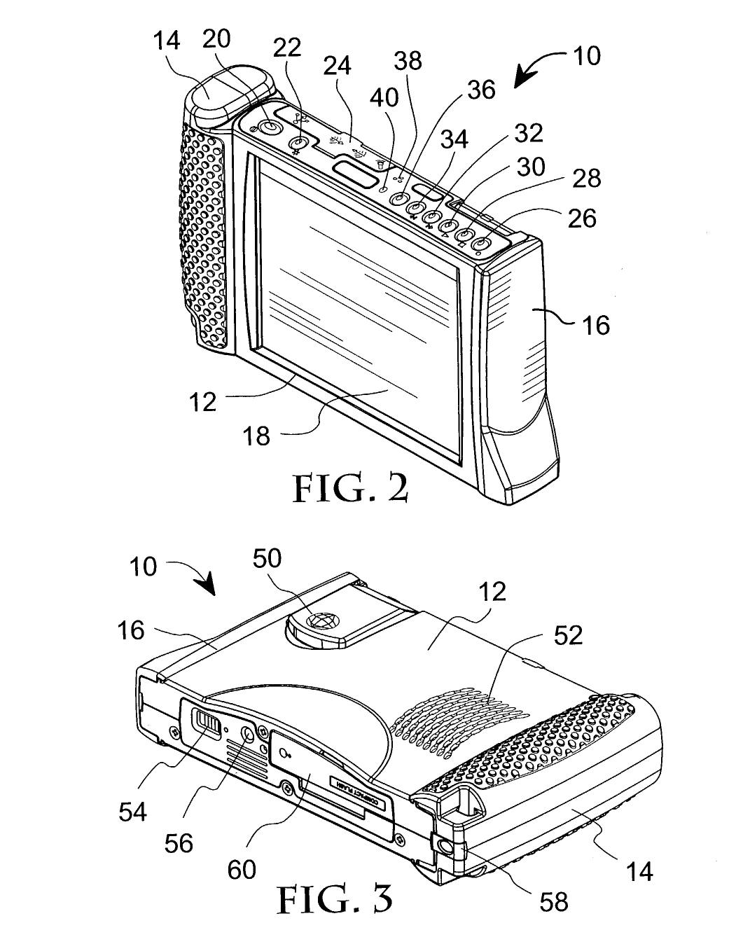

With reference to FIG. 1, at least one of the expansion modules 14 is preferred to be a battery pack for powering the core module. This module is removable and replaceable with a similar module 14, allowing rapid and convenient replacement of the battery. Module 16 can be substituted with another battery pack, so that the device can maintain at least one charged battery at all times. The module 16 may provide other supplemental functions, as well. For example, it may provide a video camera input, special antenna capability, another type of detection, another type of data gathering, another type of communication, or it may provide another power source. If a functional expansion pack is not required at one of the end positions, a protective end cap 16 can be used to keep dirt out of a D.C. electrical connection plug or socket 44 at the base of each end wall or the core module. As shown in FIG. 1, each expansion module 14, 16 engages the end walls of the core module by mating tongue-in-groove structures 46, 48, which allow a module to slide down the end wall and engage the electrical connection port 44 at the base of the end wall.

With reference to FIG. 3, the core module contains a GPS device, which may be of modular construction so as to be removable and installable into an internal expansion dock. A GPS subsystem may consist of an antenna, a GPS module, communication protocol, and suitable firmware. The back face of the core module 12 carries a closure door 50 at the internal expansion dock. The door may be adapted to receive a GPS antenna shown as the globe design on dock cover 50, linked to the internal GPS device. A speaker 52 allows playback of recorded materials or permits the device to generate audible information. The bottom face of the core module carries a docking station connector 54. A standard threaded mounting socket 56 allows the device 10 to be attached to any desired fixture, for example by a suitable tripod mount adapter. Thus, the device can be attached to a golf cart, pull cart, golf bag, or other desired mounting base. The bottom face also carries a latch 58 for locking the battery pack 14 in place. Finally, a covered compartment 60 may protect additional components and connection ports. These may include a connector for recharging the battery pack or for using the device on grid power. The protected compartment also may contain one or more slots suited for receiving a compact flash memory card or hard drive. A compact flash subsystem may consist of a compact flash card, a compact flash connector and ejector, compact flash firmware, and suitable compact flash electrical design and layout.

In greater detail, a golfing electronic assistant device 10 is a personalized scoring, statistics collecting, and distancing system designed and engineered to significantly enhance the golfing experience, dramatically improve the golfer's game, and facilitate improved course operations. Designed as a personal tool for the golfer, the golfing device combines the tradition of the game with state-of-the-art GPS (Global Positioning System) distance technology to significantly enhance the golfer's game. The device contains a full spectrum of graphical, scoring, and statistical collection features, making it a versatile tool for every level of golfer, from the novice to the professional. The golfer decides what capabilities to use. The primary features of the device 10 are:

Graphical Hole and Green Overview—Beginning at the first tee box, as a golfer approaches each hole, the golfing device or system displays a graphical overview of the hole featuring distances to the pin, fairway hazards, landmarks, and an elapsed timer to monitor pace of play. As the golfer moves down the fairway, the system displays the golfer's position in relation to defined markers on the course. The golfer can obtain marker information for a given course from an Internet web site, or the device's versatility enables the golfer to dynamically build his/her own customized graphical representation of the course in real time.

Exact Distancing—Using GPS technology, the golfing device provides distancing from the golfer's current location to every pre-defined marker on the course, allowing golfers to view the distance of their drive, distance remaining to the green, or distance to the next marker or hazard.

Electronic Scoring and Statistics Collection—The electronic scoring and statistics collection features of the golfing device require very little interaction from the golfer. Most is done automatically at the simple touch of a finger. The device can score and collect statistics for up to five players per round. The innovative graphics displays the hole number, par, handicap, player designation, club selection, number of putts, number of penalty strokes, greens and fairways in regulation, saves, sand-saves, ups/downs, chip-ins, and total score. These easy to use features automatically add the scores for each hole and display the current scoring totals and statistics for holes played. The information collected by the device belongs to the golfer, who can take it home and use it to prepare statistical and game analysis reports which facilitate the development of a personal training program to improve the golfer's game.

Intelligent Club Selection Tips—Combining the unique GPS and comprehensive statistical collection features, the golfing device learns the golfer's game. As the golfer approaches a shot, the device gives helpful hints on club selection based on historical statistical information. This feature is automatically provided for every golfer in the device's database.

The golfing device is ergonomically engineered and designed specifically to improve the golfer's game and speed up play on the course while allowing golfers to score their rounds at “the-touch-of a-finger” using software buttons on a graphical user interface displayed on the touch screen. The device is both fun and easy to use, and the device's small size as well as its weather resistant and rugged design provides golfers with a tool specifically suited for the rigors of the golf course or practice tee.

In summary, the golfing device may track or provide the following functions and information:

Scoring

Handicap

Yardage

Length of approach shots

Length of drives

Number of putts

Eagles, Birdies, Pars, Bogeys, etc.

Sand saves

Penalty shots

Chip-ins

Number of fairways in regulation

Number of greens in regulation

Up and Downs

Number of saves

How the player compares to other players

Immediate distance feedback via GPS

Immediate access to PGA Golf Rules

The base unit is a small, compact, light-weight, GPS (Global Positioning System) capable, easy to use touch screen device that automatically scores a round of golf while simultaneously collecting statistics on each player, providing immediate feedback regarding club selection and tips as well as distances to the green, hazards and other markers on the course.

The device learns the golfer's game as it is used. Once a golfer plays one round with the golfing device, the device offers tips on club selection based on where the golfer is and the distance to the green or other markers on the course.

The device has a larger display than a personal data assistant (PDA) type device, but is still small enough and lightweight enough to carry around or store in the golf bag. In addition, it can be mounted to the golf cart or a pull cart or it can be strapped to the golf bag for easy access during play.

The larger display allows for more information to be seen, even in outdoor environments. Information is input using the tip of the finger, so a stylus is not necessary. It's easier to use than keeping a manual scorecard. Thus, speed of play is improved on the course.

The device is built with the golfer in mind. It will speed up play rather than slow down or distract the golfer, while simultaneously scoring the round, calculating the players' handicap, and collecting statistics that can be analyzed for a personalized training program.

The onboard GPS capability enables the golfer to take the device to any course in the world and begin using it immediately. There is no dependency on the golf course to provide any resources. The device is totally personalized and self-contained, and can be used anywhere in the world with equally reliable results. The touch screen may display a gage for GPS signal strength and a GPS icon box indication. An audible alarm or indicator on the base unit may alert to golfer to capture and loss of GPS signal. Both the GPS device and the audible alarm may be enabled and disabled by the golfer.

The base unit has audio recording and playback capability, giving the golfer immediate access to personalized, on-the-course tips. Tips may be offered by a prerecorded golf professional. Golf tips may be user selected. Other audio comments may be related to GPS position.

Immediate access to the complete PGA rulebook gives the golfer answers to the many questions often encountered on the course. A desktop software package may be included with the system to give the golfer a full range of reports, which can be used to design an individual training program. In addition, the desktop software enables the golfer to download fully GPS capable course information from a web site or other available data source.

An instruction manual will assist the golfer to analyze this data to better understand his game. This may contribute to understanding the “mental” side of the game and provide real answers on how to improve his game, such as by considering these questions:

How to play on holes on which you get a handicap stroke?

How well does the player drive the ball or lay up on special holes such as par fives?

What pattern does the player exhibit after making a birdie, or a couple of pars in a row?

Reasons why that may happen and ways to improve.

How many times do you hit the green when using a 3-wood, 5-wood, etc.?

Other features of the product are a similar user interface as other handheld electronic devices, for ease of use; use of batteries that are easily found in the market, preferably at the golf course; and a modular design enables consumers to easily upgrade their device as enhancements become available.

The hardware platform for a device 10 may be constructed in a best mode by using the following example components or their functional equivalents or functionally similar substitutes:

Power PC processor—An MPC823 processor can be used in the golf unit. This processor runs at a 50 MHz processor speed and has a throughput rating of 55 MIPS. An 81 MHz MPC823E version can be installed to increase throughput to about 110 MIPS. This is adequate computing power for such applications as video compression and decompression, data and communications encryption and decryption, speech recognition and synthesis, map display and route guidance, MP3 encoding and decoding for music and speech record and playback, and others.

A digital signal processor (DSP) and audio system—A Scoreboard audio system includes a DSP56364 digital signal processor. This is a low cost unit designed for consumer products and is a suitable way to interface to an audio system. In spite of the low cost, it is capable of 100 MIPS throughput. It is connected to the power PC processor via a high-speed link that allows an effective doubling of the available processing power in many applications. To further support this capability, the PC board was designed to accept a memory device dedicated to the DSP. Such a memory device need not be loaded for the golf application. The audio system is capable of CD quality recording and reproduction. A large planar speaker provides a high quality sound. The DSP capability allows the implementation of filtering and other sound enhancement techniques.

The unit may signal via tone and flashing icon when a recording is present for a specific hole on a specific golf course. A recorder screen or window should appear only when recording. During a round of golf, when the golfer receives an audible and visual indicator that a recording exists for this hole, the golfer should be able to simply touch the visual indicator to begin hearing the audible playback . . . the recorder screen should not appear during playback. The record time may be flashcard limited, such as with a minimum of eight minutes per course.

Memories—A memory system is based on a single 512M FLASH memory device and two SDRAM memory devices that permit total RAM capacity to be selected from 16 Mbytes to 128 Mbytes. The larger sized memory would be useful to support video recording and playback.

Compact flash/Hard drive slot—A compact flash card slot allows large databases to be installed. A suitable size currently is 512 Mbytes, but this can be increased as desired. 512M is 80% that of a CD-ROM, allowing such databases as several thousand pages of books, maintenance manuals, patient records, reference guides, road maps of the entire US, 6-7 MP3 format music CDs, etc. With additional firmware, the unit could support compact flash sized hard disks, which currently are available in sizes up to 10 Gbytes—a 20:1 increase in storage.

Display system—The golf unit is based on a 320×240 TFT color display. This unit is especially suited to outdoor applications that require sunlight visibility. Because of the TFT design, response is very fast, allowing the unit to display video. The display controller is capable of handling higher resolution screens such as VGA and SVGA. With a different housing, the main board could be used for applications requiring these larger displays. A 6.4″640×480 color TFT display is available that might be suitable for military applications.

Modular Design—A feature of the design that makes it readily adaptable to multiple and varied applications is its modularity. There are three modules—two side modules, and a central or internal module. Each side can accept a user changeable module that can be selected from the group consisting of a battery, an added function such as a digital camera, a medical vital-signs module, a package scanner, a two-way radio, an automotive computer bus interface, or combinations of these. An internal module is built into the rear housing of the unit. In the golf application, this is the GPS. An internal communications subsystem may consist of hardware, suitable protocol, and suitable firmware. The hardware interface includes a top external connector parallel with a docking connector; a left module; a right module; the internal (GPS) module; a docking connector; and an infrared module. The docking station protocol may be USB 1.1, with batch process and no real time streaming. GPS unit protocol may be UART. The left side module, typically a battery, may use I2C protocol. Right side module protocol may be USB 2.0 for video. The top connector may be in parallel with the docking connector

USB hub—The unit features a 12 Mbit/S data rate USB connection along the top edge, which allows it to connect to various USB devices or a PC. Maximum use has been made of the USB capability by building a USB hub into the unit that connects to each of the three modules, the top connector, and the docking connector on the bottom. This allows for great flexibility of interfacing and future expansion, and is more cost effective than the SMB bus commonly used with intelligent battery packs.

Battery/power system—A battery charger is built into the unit, permitting charging to be accomplished using only an inexpensive off-the-shelf wall plug power supply. This removes the requirement of supplying a charging cradle with the unit, saving cost. The internal charger supports dual battery operation, where a battery is mounted to each side. In his mode the unit can operate non-stop indefinitely as long as fresh batteries are available. The charger can support larger and smaller batteries, as well as batteries based on other technologies. The unit can also operate from existing plane/car power adapters commercially available from commercial suppliers such as Targus, Kensington, and others.

Power management—In order to maximally extend battery life, the unit incorporates a variety of power saving features. The clocks of both the Power PC and the DSP are programmable, allowing each to be slowed down to save power when full speed is not needed. The DSP, audio system, and compact flash can be turned off to save power when they are not being used. The power can be individually switched off for any unused USB ports. The display can be set to turn off automatically if it is unused for a specified period of time. Code is loaded from the flash to run in SDRAM memory, allowing the flash to enter idle state, saving more power. A PIC processor that manages the touch-screen spends most of its time in a low-power “sleep” mode.

Buttons and touch screen—The top front edge of the unit features buttons for the audio recorder function of the golf unit. This area is designed so that the number and function of these buttons can be easily changed to suit other applications.

As mentioned above, modified hardware and software allow a similar device to be used as an aid to playing baseball or softball. The baseball device can assist baseball and softball managers, coaches, scouts, players, and fans in scoring, collecting individual, team, and game statistics, and making immediate game situation decisions. Although baseball and softball are among the most pertinent applications of such a device, additional similar devices can provide state-of-the-art computer software, electrical, and mechanical engineering technology to provide similar information collection and presentation capabilities to other sports, games, competitions, or industries.

A functional overview of how the golfing assistant device is used demonstrates the capabilities of the hardware and software. The display screen can be menu driven to provide software buttons that are finger-operated. Software buttons, menus and functions are described below to illustrate some of the preferred schemes that can be programmed into the device 10.

Turn the device on by pressing the hardware power button 20. The display immediately shows the INTRO DISPLAY, which is a title screen that can show a photo of a plush golf hole with a graphic title identifying the device trademark or other introductory information. A golf course might use its own picture on the Intro Display screen. The INTRO DISPLAY includes a soft START and a QUIT button, each finger operated on the touch screen.

### Start

Press the START button to begin. The display shows a picture of the golf clubhouse and a number of soft key selections. Simply touch the desired selection and begin. The following specification describes the functionality of each graphical display and touch button in order to step the golfer through the process.

### Back

A soft BACK key is frequently displayed. When the BACK key is pressed on any screen, the device should retain the data from the previous screen so that going back does not require re-entering all the data.

From the CLUB HOUSE screen, touch NEW ROUND to continue or touch QUIT to turn the device off. The New Round key brings up COURSES menu.

### New Round

Functional Description: The NEW ROUND selection indicates the golfer wishes to begin playing a round of golf. The general sequence of events is:

1. Select a course (or indicate a new course)

2. Select the players (or indicate new players)

3. Select the tees for each player

4. Begin playing the round, using the golfing assistant device to provide scoring and distance information with the onboard GPS capabilities.

The following specification describes the functionality of each graphical display and touch button in order to step the golfer through he process.

INTRO DISPLAY: Press START to begin.

CLUB HOUSE: Touch NEW ROUND to continue, or touch QUIT to turn the device off.

COURSES: The device now displays a list of courses in alphabetical order and several touch buttons. The golfer may select a course listed, may display the scorecard of a course that is listed, may specify a new course, or may go back to the previous display.

To select a course listed: Touch the course to be played, and then touch an OK button. Arrow buttons are available to scroll through the courses. Once the OK button is touched, the PLAYERS selection is displayed.

To specify a new course: Touch a NEW button, and the device transfers control to the NEW COURSE function (See COURSES description).

To view the scorecard for a specific course: Touch the desired course, and then touch the SCORECARD button. The scorecard for that particular course is displayed, and then control returns to the COURSES function.

Touch the BACK button to return to the previous display.

PLAYERS: The device now displays a list of players in alphabetical order and several touch buttons. The device systematically steps the user through the process to select any number of players (up to a total of 5 players), specify a new player, specify which tees each player will play (required in order to get correct slope/rating information for accurate calculation of handicaps), or may go back to the previous display.

To select players for this round: Touch ALL the players' names that will be playing in this round, then touch the OK button.

To add a new player: Touch the NEW button, and the device transfers control to the NEW PLAYER function (see PLAYERS description)

Touch the BACK button to return to the previous display.

PLAYER'S TEES:

Touch the appropriate indicator box for the tees each player will play, then touch the OK button.

Touch the BACK button to return to the previous display.

SCORECARD: Once all players have selected the tees they will play, a graphical image of the scorecard is displayed. The user may toggle back and forth between holes 1-9 and holes 10-18.

To begin playing the round, touch the PLAY button. The device transfers control to the HOLE 1 function. In addition, a Round record is built for each player in order to begin accumulating score and statistical information.

Use the 10-18 and 1-9 buttons to toggle the scorecard.

Use the BACK button to return to the previous display.

HOLE 1: This is the primary display the golfer will use during the round. It has all the functions and information necessary to accurately score the round and provide distance information for each golfer. For each shot, based on the player's history, the recommended club selection is highlighted. The GPS distance to green is automatically shown ALWAYS. The distance shown in the top right hand corner of the display is the yardage as taken from the course scorecard . . . for this hole, for this tee. The following describes the functions of this display.

Function: To change players—Touch the player's name, and a pull-down list of players playing this round appears. Touch the applicable player, and the display immediately reflects that player's information on a cumulative basis. That is, the device stores each specific player's information as it occurs (see Round record in database description), and when a different player is selected, his/her information for that specific hole is pulled from the database.

Database Fields Involved:

Key for each player:

RPNUMB (Player Number)

RCNUMB (Course Number)

RCDATE (Date the round is played).

Round record from which to pull specific data for this hole:

RPNUMB

RCNUMB

RCDATE

Total=RTHOLE#, where #=hole being played

Putts=RPHOLE#, where #=hole being played

LCR=RFHOLE#, where #=hole being played

Green=RGHOLE#, where #=hole being played

Penalty=RPSHOLE#, where #=hole being played

Save, Sand Save, Chip-in, Up/Down=RMHOLE#, where #=hole being played.

Function: To change holes—Touch the flag in the top right corner of the display . . . a pull-down menu of holes (1-18) appears. Touch the desired hole. The display immediately displays the information for that specific hole for that specific player or players.

Function: Clubs—The clubs displayed are specifically for the player's name displayed in the Player Name field.

Database Fields Involved:

PCLUB 1-PCLUB 16

Each player may have a different set of clubs . . . this is established when the player is entered into the system.

If a player's shot lands on the green, then his next club is likely to be a putter. In this case, the distance of the previous shot should be calculated by measuring the distance from the center of the green to the location of the previous shot.

Club Recommendation: For the specific player indicated, the recommended club selection for that particular player is highlighted. This club recommendation is determined by comparing the GPS distance to the center of the green with the average distance the player hits his/her clubs. The club highlighted must be the club with a distance that is the closest, but not greater than, the GPS distance to the center of the green. The exception is that the 1 Wood can only be used on the first shot of each hole. If the 1 Wood turns out to be the best match for a given shot, other than the first shot on a hole, then drop to the next longest club. This club recommendation must be constantly updated as the golfer moves down the fairway toward the green.

Database Fields Involved:

PDIST#, where #=1-16 (player's clubs 1-16)

Club Selection: The player touches the selected club to indicate he/she has taken a shot. The following actions occur:

Highlight the selected club in RED momentarily.

Add 1 to RTHOLE#, where #=hole being played; move RTHOLE# to Total on display.

Capture GPS coordinates of this current location in order to calculate the distance of the previous shot.

Calculate distance of previous shot: The touching of a selected club by the player indicates (as close as possible) where the ball lies after the previous hit. Therefore, we must calculate the distance of the previous shot . . . unless this is the original tee shot on a particular hole. Formulas are:

First two digits of RSXHOLE# (where X is the hole begin played and # is the sequential number of the shot for this hole)=01-16 indicating previous club selection.

Last three digits of RSXHOLE# (where X is the hole begin played and # is the sequential number of the shot for this hole) distance of last shot, rounded up to nearest yard. (GPS PREVIOUS−GPS CURRENT)

Update average distance for previous club used. Formula is:

PDIST#=total yardage hit with club/total times club is hit.

Database Fields Involved:

RTHOLE#, where # hole being played.

RSXHOLE#, where X=club used and # hole being played. PDIST#, where # hole being played.

Function: Fairways—Used to indicate whether player's tee shot was in the left (L) of the fairway, center (C) of the fairway, or right (R) of the fairway.

Player touches L, C, or R on the display to indicate tee shot position. The following actions occur:

Highlight L, C, or R in RED initially, then GREEN and leave GREEN.

Database Fields Involved:

RFHOLE#, where #=hole being played.

Function: Green—Used to indicate if player hit the green in regulation . . . i.e., if the player is putting for birdie (one less than par) and the ball is physically on the green, then the player made the green in regulation.

Player touches Green on the display to indicate making the green in regulation. The following actions occur:

Highlight Green in RED initially, then GREEN and leave GREEN.

Database Fields Involved:

RGHOLE#, where #=hole being played.

Function: Save, Sand Save, Chip-in, Up/Down—Used to indicate if player did not hit the green in regulation, but was still able to make par on the hole (Save); if player saved the hole from a sand bunker shot (Sand Save); if the player chipped a ball from off the green into the hole (Chip-in); or if the player was off the green, and finished the hole in two shots from that position (Up/Down).

Player touches Save, Sand Save, Chip-in, or Up/Down on the display. The following actions occur:

Highlight Save, Sand Save, Chip-in, or Up/Down in RED initially, then GREEN and leave GREEN.

Database Fields Involved:

RMHOLE#, where #=hole being played. The appropriate digit in RMHOLE# is set on as applicable.

Function: Adjust Putts, Penalty, or Total—Used by the player to manually enter or adjust the number of putts on a hole, number of penalty strokes on a hole, or the total score on a hole.

Player touches Putts, Penalty, or Total on the display, followed by touching the up/down arrow keys to adjust the appropriate counter. The following actions occur:

Highlight Putts, Penalty, or Total in RED while adjustment is ongoing.

Highlight the touched up/down arrow button in RED when touched.

Each touch of the up/down arrow button adds or subtracts one stroke as appropriate

Database Fields Involved:

RPHOLE#, where #=hole being played.

RPSHOLE#, where #=hole being played.

RTHOLE#, where #=hole being played.

RSHOLE#, where #=hole being played. Note: Set to “PR” if RTHOLE#=par for this hole (first digit of CT1PHY#); set to “BR” if RTHOLE#=par−1 for this hole; set to “EG” if RTHOLE#=par −2 for this hole; set to “BG” if RTHOLE#=par +1 for this hole; set to “DB” if RTHOLE#=par +2 for this hole; set to “TB” if RTHOLE#>=par +3 for this hole.

Function: GPS Yardages—Used by the player to display graphical representation of hole and yardages from where he/she is to various markers on the course.

Player touches GPS Yardages on the display, and control transfers to the GPS Yardages function.

Function: Scorecard—Used by the player to display graphical representation of the scorecard for this round, this course, completely filled in with current statistics from the database.

Player touches Scorecard on the display, and control transfers to the Scorecard function.

Function: Previous Hole—Used by the player to display the previous hole's statistical information.

Player touches Previous Hole on the display, and the previous hole's statistics are displayed for the specified player or players.

Function: Next Hole—Used by the player to display the next hole's statistical information.

Player touches Next Hole on the display, and the next hole's statistics are displayed for the specified player or players.

GPS YARDAGES: This is the second most important and most often used display a golfer will use during play. It's purpose is to provide GPS yardage information to the center of the green and to the front, back, right, left, and center of other custom selected markers for the selected hole, as well as to allow the golfer to add new markers as he plays. The graphical display on the right shows real time updated information (based on constant readings from GPS) indicating the exact yardage from the golfer (displayed as an icon moving down the fairway, i.e. a golfer swinging a club, a golf cart, etc) to the specified markers. The marker icons on the left and the L (left), R (right), C (center), and B (back) buttons are used to select additional markers during play. If there are no markers specified for the course in the database, then the golfer is instructed to add at a minimum the tee box and the center of the green. If there are no markers specified for the course, then the graphical display should be blank except for the tee box and the green. The green should always be at the top, and the tee should always be at the bottom. The user should be able to move the icons around to show relative position consistent with the course. When new markers (icons) are added, then the location of the icon on the right side of the display should be determined by calculations of GPS coordinates already known for the hole.

Function: To Add a Marker—The player uses this function to add a new marker to his course layout and capture the GPS coordinates for future use. The player positions himself/herself directly on top of the exact location of the marker they wish to add. For example, if the golfer is adding a sand bunker, the he/she may wish to capture both the front and the back of the bunker (so they can know in the future exactly how far they have to hit a ball to clear or come up short of the bunker.

The player touches an icon on the left to indicate what type of marker to add. The following actions occur:

Highlight the selected icon RED.

The player touches L, B, C, R, or F to indicate what position of the marker to capture. The following actions occur:

Highlight the selected icon RED.

The player touches the Capture button to indicate they are ready to capture and add that marker. The following actions occur:

Highlight the selected icon RED.

The selected icon is added and placed on the graphical display relative to where the green, tee, and golfer are.

Function: Play—The player touches this button to return to the HOLE # display, where the hole being played.

SCORECARD: The scorecard is displayed with all applicable data from the database, including the player's score on each hole thus far and all course yardage information from the Course Database Description for this course. The following actions apply:

Function: Cumulative Score—Each player's cumulative score is shown as −, E, + along side his/her name . . . based on the score for all completed holes up to this point. For example, consider this scenario: Hole 1 is a par 5 hole, hole 2 is a par 4 hole, and hole 3 is a par 3 hole. If the golfer has a total of 13 strokes this round, then his cumulative score is +1. If the golfer has a total of 12 strokes this round, then his cumulative score is E. If the golfer has a total of 10 strokes this round, then his cumulative score is −2.

Database Fields Involved:

CTXPHY#, where X is the tee and # is the hole being evaluated.

RTHOLE#, where # is the hole being evaluated.

Function: Play—The player touches the Play button to resume play or continue to the next display if this is the last hole.

### Continue Rounds

Functional Description: The CONTINUE ROUNDS selection indicates the golfer wishes to continue playing a round of golf which may have been postponed or delayed for any reason. The general sequence of events is:

1. Select a round from the list of incomplete rounds.

2. The device brings up the appropriate scorecard.

3. Begin playing the round, using the golfing electronic assistant device to provide scoring and distance information with the onboard GPS capabilities.

The following specification describes the functionality of each graphical display and touch button in order to step the golfer through the process.

INTRO DISPLAY: Press START to begin.

CLUB HOUSE: Touch CONTINUE ROUND to continue, or touch QUIT to turn the device off.

ROUNDS: The device now displays a list of rounds played . . . listed chronologically by date and course played. The golfer selects a round by touching the appropriate date or course or may go back to the previous display.

To select a round listed: Touch the round to be resumed, and then touch the OK button. Use the arrow buttons to scroll through the rounds. Once the OK button is touched, the SCORECARD for the selected round is displayed.

Touch the BACK button to return to the previous display.

SCORECARD: The scorecard is completely filled in with information from the applicable course and round database records. The user may toggle back and forth between holes 1-9 and holes 10-18.

To begin playing the round, touch the PLAY button. The device transfers control to the HOLE # function, where #=the next hole to be be played (one greater than the last completed hole).

Use the 10-18 and 1-9 buttons to toggle the scorecard.

Use the BACK button to return to the previous display.

HOLE #: Control transfers to the HOLE # display. From this point, the device functions identically as if this is a new round being played. (See NEW ROUND). Note: the date of the round should be changed to the new date.

### Courses

Functional Description: The COURSES selection indicates the golfer wishes to add a new course or view/edit the information in an existing course. The general sequence of events is:

1. Select a course from the list of courses.

2. View/edit the information for the selected course.

3. Add a new course.

The following specification describes the functionality of each graphical display and touch button in order to step the golfer through the process.

INTRO DISPLAY: Press START to begin.

CLUB HOUSE: Touch COURSES to continue, or touch QUIT to turn the device off.

COURSES: The device now displays a list of courses . . . listed alphabetically by course name. The golfer selects a course by touching the appropriate course, selects NEW to enter a new course, or may go back to the previous display.

To select a course: Touch the desired course, and then touch the OK button. Use the arrow buttons to scroll through the courses. Once the OK button is touched, the COURSE INFORMATION for the selected course is displayed.

To view scorecard: Touch the desired course, and then touch the SCORECARD button.

To add a new course: Touch the NEW button. Control transfers to the COURSE INFORMATION display where the golfer enters appropriate course information.

Touch the BACK button to return to the CLUB HOUSE.

COURSE INFORMATION: This display allows the golfer to enter or edit course information.

Course Name, City, State, Phone, and Pro: Touch the appropriate box, then using the alpha numeric keys, enter or edit the appropriate course information. Note: Only the Course Name is required.

Database Fields Involved:

CNAME

CNUMB

CCITY

CSTATE

CPRO

CPHONE

Touch the OK button to save the course information.

COURSE TEES: This display allows the golfer to enter or edit course tee information.

9 or 18 Holes: Touch the appropriate button.

Database Fields Involved:

C90R18

Tee Descriptions: Touch the appropriate tee position box, then using the alpha numeric keys enter the tee names. Note: Tees MUST be entered from left to right, shortest to longest.

Database Fields Involved:

CTNAME#, where #=1-6 indicating different tee placements.

Touch the OK button to save the tee information.

COURSE RATING: This display allows the golfer to enter or edit course-rating information.

Rating & Slope: Touch the appropriate box, then using the alphanumeric keys, enter or edit the appropriate rating information. Note: These fields are required to accurately calculate player handicaps.

Database Fields Involved:

CTRTG#, where #=1-6 corresponding to appropriate tee (Note: must correspond to CTNAME#)

CSLOPE#, where #=1-6 corresponding to appropriate tee (Note: must correspond to CTNAME#)

Touch the OK button to save course rating and slope information.

COURSE YARDAGE: This display allows the golfer to enter or edit course yardage information.

Select the appropriate tee: Touch the appropriate box to indicate which tee to enter yardage for, then touch the OK button.

YARDAGE/PAR/HCP FOR “COLOR” TEES: This display allows the golfer to enter or edit course yardage, par, and handicap information.

Yardage, Par, Handicap: Touch the appropriate box, then using the alphanumeric keys, enter or edit the appropriate information.

Database Fields Involved:

CTXPHY#, where X=1-6 corresponding to appropriate tee (Note: must correspond to CTNAME#), and #=-1-8 corresponding to the hole.

Touch the OK button to save course yardage, par, and handicap information. Control transfers to the scorecard for this course.

SCORECARD: This display gives the golfer a “scorecard” view of the course information entered or edited.

Use the 10-18 or the 1-9 buttons to toggle the scorecard.

Touch the MORE button to return to the COURSE YARDAGE display to enter more yardage, par, and handicap information.

Touch the BACK button to return to the YARDAGE/PAR/HANDICAP display to enter or edit information.

Touch the OK button to return to the COURSES display.

### Players

Functional Description: The PLAYERS selection indicates the golfer wishes to add a new player or view/edit the information for an existing player. The general sequence of events is:

1. Select a player from the list of players.

4. View/edit the information for the selected player.

5. Add a new player.

The following specification describes the functionality of each graphical display and touch button in order to step the golfer through the process.

INTRO DISPLAY: Press START to begin.

CLUB HOUSE: Touch PLAYERS to continue, or touch QUIT to turn the device off.

PLAYERS: The device now displays a list of players . . . listed alphabetically by players' last name. The golfer selects a player by touching the appropriate player, selects NEW to enter a new player, or may go back to the previous display.

To select a player: Touch the desired player, and then touch the OK button. Use the arrow buttons to scroll through the players. Once the OK button is touched, the PLAYER INFORMATION for the selected player is displayed.

To add a new player: Touch the NEW button. Control transfers to the PLAYER INFORMATION display where the golfer enters appropriate player information.

Touch the BACK button to return to the CLUB HOUSE.

PLAYER INFORMATION: This display allows the golfer to enter or edit player information.

Player Name (first and last), Handicap, Righty/Lefty: Touch the appropriate box, then using the alpha numeric keys, enter or edit the appropriate course information. Note: Only the Player Name is required.

Database Fields Involved:

PNAMEF

PNAMEL

PNUMB

PLFTRGT

PHCP

Touch the OK button to save the player information.

PLAYERS CLUBS: This display allows the golfer to enter or edit player club information.

The screen shows the player's name, and 16 buttons representing the clubs the player may select. The player may select up to 16 clubs. The following clubs are default clubs, which represent the typical set of clubs. The default clubs will be automatically highlighted so that the player may simply add or change the clubs as appropriate, up to a maximum of 16 clubs.

1W,3W,5W, 3, 4, 5, 6, 7, 8, 9, PW, SW, P

Database Fields Involved:

PCLUB 1 thru PCLUB 16

Touch the OK button to save the player club information.

### Continue Round

Functional Description: The CONTINUE ROUND selection indicates the golfer wishes to continue a previously uncompleted round. The general sequence of events is:

1. Select a round from a list of rounds displayed by date.

2. Begin playing where the round left off.

The following specification describes the functionality of each graphical display and touch button in order to step the golfer through the process.

INTRO DISPLAY: Press START to begin.

CLUB HOUSE: Touch CONTINUE ROUND to continue, or touch QUIT to turn the device off.

COURSE: The device now displays a list of rounds . . . listed chronologically by date and course. The golfer selects a round by touching the appropriate course or date, or may go back to the previous display.

To select a round: Touch the desired course or date, then touch the OK button. Use the arrow buttons to scroll through the rounds if necessary. Once the OK button is touched, the SCORECARD for the selected course and round is displayed. Note: The scorecard contains all information for this round previously stored in the database.

Touch the BACK button to return to the CLUB HOUSE.

SCORECARD: This display shows the scorecard for the selected course and round.

Touch the 10-18 or 1-9 buttons to view the scorecard.

Touch PLAY to begin playing where the round left off. Note: From this point on, functionality continues as if the player were playing a new round.

### Reports

Functional Description: The REPORTS selection indicates the golfer wishes to prepare, view, and/or print a report. The general sequence of events is:

1. Select a report from a list of available reports.

2. Select a player for which to prepare the report.

The following specification describes the functionality of each graphical display and touch button in order to step the golfer through the process.

INTRO DISPLAY: Press START to begin.

CLUB HOUSE: Touch REPORTS to continue, or touch QUIT to turn the device off.

REPORTS: The device now displays a list of available reports . . . listed alphabetically by report name. The golfer selects a report by touching the appropriate report or may go back to the previous display.

To select a report: Touch the desired report, and then touch the OK button. Use the arrow buttons to scroll through the reports if necessary. Once the OK button is touched, the report preparation sequence begins. Note: The golfer may be asked for additional information depending on the report.

Touch the BACK button to return to the CLUB HOUSE.

SCORECARD: This display shows all rounds stored in the database, listed chronologically by date and course name. The golfer may select a round to prepare and print a scorecard. Note: The information on the scorecard comes from the database for that specific round.

Select the round by touching the date or course name.

Touch VIEW to view the scorecard on the screen.

Touch PRINT to print the scorecard.

A sample scorecard print is shown in the Reports section.

STATISTICS REPORT: This display allows the golfer to view or print a current statistics report for a specific golfer. The golfer is allowed to select which rounds he/she wishes to be included in the calculation of his/her statistical report.

Select the name of the golfer by scrolling through the available list and touching the applicable golfer. Note: The primary user should always be the default selection.

Select the rounds to be included in the report by touching the indicator column to the left of the rounds. Note: The golfer may deselect all or select all rounds, or may select a single round as applicable. The statistical information is calculated based only on the information from the selected rounds.

Touch VIEW to view the report on the screen.

Touch PRINT to print the report.

A sample Statistical Report along with formulas is included in the Report section.

GAME ANALYSIS: This display allows the golfer to view or print a current game analysis for a specific golfer. The game analysis is based on all rounds that the golfer has played. Specific functionality for this feature can be derived from any of the data gathered in the golfing assistant, correlated with analysis pointers to produce suitable advice.

TRAINING PROGRAM: This display allows the golfer to view or print a specifically designed training program for a specific golfer. The training program is based on an analysis of all rounds that the golfer has played. Specific functionality for this feature can be derived from any of the data gathered in the golfing assistant, correlated with training pointers to recommend suitable remedial steps.

### Handicap

Functional Description: The HANDICAP selection indicates the golfer wishes to manage his/her USGA handicap. The golfer may select all rounds for a particular player, or may select any combination of rounds. For example, the golfer may wish to compute his handicap for all rounds, for a specific course, for his tournament rounds, etc. The general sequence of events is:

1. Select a player for which to compute the handicap.

2. Select the round(s) for which to compute the handicap.

The following specification describes the functionality of each graphical display and touch button in order to step the golfer through the process.

INTRO DISPLAY: Press START to begin.

CLUB HOUSE: Touch HANDICAP to continue, or touch QUIT to turn the device off.

HANDICAP: The device now displays a list of rounds played, listed chronologically by date for the selected player, and the computed handicap based on the rounds selected.

To select a player: Scroll through the player list to select the desired player. Note: The primary user is the default player.

To select rounds: Use the SELECT ALL, DE-SELECT ALL, and individual selection buttons to select applicable rounds. The selected rounds are added to a handicap computation list, which may be displayed on the right side of the display.

Once all rounds are selected, simply touch the COMPUTE button to compute the handicap, which is calculated using the USGA handicap formula. Note: The handicap automatically displayed for a player at the start of a new round is the handicap calculated based on ALL rounds.

Touch the BACK button to return to the CLUB HOUSE.

### Statistics

Functional Description: The STATISTICS selection indicates the golfer wishes to manage his/her statistics. Statistics fall into two categories, General Statistics and Performance Statistics. The golfer may select all rounds for a particular player, or may select any combination of rounds. For example, the golfer may wish to compute statistics for all rounds, for a specific course, for tournament rounds, etc. The general sequence of events is:

1. Select a player for which to compute statistics.

2. Select the round(s) for which to compute statistics.

The following specification describes the functionality of each graphical display and touch button in order to step the golfer through the process.

INTRO DISPLAY: Press START to begin.

CLUB HOUSE: Touch HANDICAP to continue, or touch QUIT to turn the device off.

HANDICAP: The device now displays a list of rounds played, listed chronologically by date for the selected player, and the computed handicap based on the rounds selected.

To select a player: Scroll through the player list to select the desired player. Note: The primary user is the default player.

To select rounds: Use the SELECT ALL, DE-SELECT ALL, and individual selection buttons to select applicable rounds.

Once all rounds are selected, simply touch the COMPUTE button to compute statistics (see attached formulas for statistics).

Touch the BACK button to return to the CLUB HOUSE.

### Upload/Download

Functional Description: The UPLOAD/DOWNLOAD selection indicates the golfer wishes to synchronize his/her hand unit with the database on his her desktop or laptop. The general sequence of events is:

1. Connect the hand unit to the desktop or laptop. Appropriate detail may be supplied in a User's Manual.

2. Select the data to synchronize (players, courses, or rounds).

3. Touch start to begin synchronization.

The following specification describes the functionality of each graphical display and touch button in order to step the golfer through the process.

INTRO DISPLAY: Press START to begin.

CLUB HOUSE: Touch UPLOAD/DOWNLOAD to continue, or touch QUIT to turn the device off.

UPLOAD/DOWNLOAD: The device now displays a selection of data to be synchronized (players, courses, and rounds).

To select data: Touch the button next to PLAYER, COURSES, and/or ROUNDS.

To begin synchronization: Touch the START button.

If synchronization is being done via the serial cable and the cable is connected properly, synchronization begins . . . and, a message is displayed to indicate the status.

If synchronization is being done via the infrared port, a message is displayed instructing the user to point the two devices together . . . then synchronization begins and a message is displayed to indicate the status.

Touch the BACK button to return to the CLUB HOUSE.

### Utilities

Functional Description: The following utility functions are to be provided:

1. Audio: The user shall have the capability to record and replay audio notes for any hole on any course. These audio notes shall be permanently stored as part of the hole and course information for future reference. Any time a player plays a hole with an audio note attached, an audible and visual indicator should alert the player that the note is present. The audio notes are NOT player specific, but rather are hole/course specific.

2. Help: The user shall have access to context sensitive help instructions on every display. The help function will describe the function of the screen as well as specific functionality of the various buttons.

3. Tips: The user shall have access to a library of golf tips organized alphabetically by subject. Actual tip content can be provided from established or custom sources.

4. Rules: The user shall have access to a library of golf rules. Rules shall be listed numerically by number and title. User shall select the basic rule, then scroll through the details of the rule as desired. See Rules section for details on content.

5. Undo: The user shall have the capability to undo single function, and by pressing the undo key repeatedly shall have the capability to undo a maximum of 10 functions.

6. Video: The user shall have the capability to record and replay videos for a specific player. The golfer shall have the capability to get the camera set up and focused, then press a button which allows the user 30 seconds to get set in his position before recording begins. This recording shall be stored in the players section of the database, and shall be considered an integral part of the players specific data. Playback of the data should allow the user to stop the video at specific points in order to check body positions throughout the swing. The video capability is enabled by addition of a video camera as one of the side modules.

Controls may be provided for System Configuration. These may include screen brightness and contrast, touch screen calibration, audible indicators enable/disable, and GPS enable/disable.

This software scheme refers to various database elements. The following tables show examples of such database elements. In Table 1, General Statistics and Handicap Report, the preferred format for the report should have the Player's Name at the top of the report, and the second line should contain a date. The golfer is allowed to select which rounds are to be included in the statistics and handicap calculation. The golfer may select ALL rounds, deselect ALL rounds, and select individual rounds to be included. A handicap can be calculated conforming to the USGA handicap index, which first requires calculation of handicap differentials. Table 2, Formulas Database Description, shows benchmarks and formulas for calculating those benchmarks from statistics in the database. Table 3, Player Database Descriptions, shows historical data about each individual player entered in the database, including clubs in the player's bag, average distance achieved with each club, and handicap. Table 4, Golf Courses Database Description, shows historical data about each individual golf course and hole, including names, ratings, and slopes for the tees, and related par, handicap, and yardage for each tee. Further, this database table records GPS coordinates to the left edge, right edge, back edge, and center of the green for each hole. Similar data can be recorded for other markers on each hole. Typically the table may hold GPS data showing front, back, left, right and center positions for each marker.

Finally, Table 5, Rounds Database Description, records the real time play of each golf hole and round. The database records an updated record for each player on total score, score adjusted for handicap, score on each hole, putts on each hole, directional characteristic and distance of drives and follow-on shots, number of penalty strokes, and whether an individual hole score is a par, birdie, eagle, etc. In addition, this table records performance with respect to each club and with respect to each shot in the play of a hole.

This record of how a player performs with each club, in each situation, provides a basis for the electronic assistant to recommend to the golfer which club is appropriate for a future situation. In addition, the content of the database allows an analysis for problem situations similar to those that have been troublesome for the player in the past. This analysis enables the electronic assistant to volunteer a pre-recorded tip, such as through the audio speaker, when a potential problem situation arises during play. The audio speaker can alert the player more effectively than can a passive message on the display screen, which the player could overlook. The value of a real time tip is that the player is informed of a possible problem and solution before he takes his shot. The corrective tip can be employed immediately, while the opportunity is present in real time to improve the game.

TABLE 1
General Statistics and Handicap Report Database Description

| General Statistics | Formula/Method of Calculation |
|---|---|
| | Note: For 9-hole statistics, a completed 9 holes means the player |
| | completes holes 1-9 or 10-18. This means a player could |
| | complete 9 holes by playing only 9 holes of an 18 hole course, |
| | leaving an incomplete 18 hole round . . . or the player could play a |
| | full 18 holes which would give him two (2) completed 9 holes. |
| | For example, if a player plays holes 3-11, this does not count as a |
| | completed 9 holes. |
| Low 18 | For all completed rounds (18 holes) played for this player, take |
| | the round with the lowest total score RPSCOREG |
| High 18 | For all completed rounds (18 holes) played for this player, take |
| | the round with the highest total score RPSCOREG |
| Low 9 | For all completed 9 holes played for this player, take the lowest |
| | total score RPSCOREG |
| High 9 | For all completed 9 holes played for this player, take the highest |
| | total score RPSCOREG |
| Avg 18 | For all completed rounds (18 holes) played for this player, Avg |
| | 18 (Sum of all scores RPSCOREG)/Number of Completed |
| | Rounds |
| Avg 9 | For all completed 9 holes played for this player, Avg 9 = (Sum of |
| | all scores RPSCOREG)/Number of Completed 9 holes |
| Performance Statistics | Note: Performance Statistics are prepared for ALL holes, all |
| | PAR 3 holes, all PAR 4 holes, and all PAR 5 holes. So, as you |
| | review the formulas you must consider this. For example, the |
| | ALL category includes all holes played, or in the case of averages |
| | 18 holes . . . whereas, the Par 3 statistics would consider only par 3 |
| | holes played (either among all holes or among 18 holes in the |
| | case of averages). So, when you are summing, in all cases except |
| | ALL, you must check for the par rating for the hole to determine |
| | if a particular hole should be included in the calculation. |
| Avg Score | For all completed 18-hole rounds, Avg Score = (Sum of all scores |
| | RPSCOREG)/Number of completed 18-hole rounds |
| Avg Over/Under | For all completed 18-hole rounds, Avg Over/Under (Sum of all |
| | (Total Par for the Course and tees played - RPSCOREG))/ |
| | Number of completed 18-hole rounds |
| Avg Triple Bogeys (plus) | For all completed 18-hole rounds, Avg Triple Bogeys (plus) = |
| | (Sum (Number of holes where RTHOLEX ≧ (Par for the hole + |
| | 3)))/Number of completed 18-hole rounds |
| Avg Double Bogeys | For all completed 18-hole rounds, Avg Double Bogeys = (Sum |
| | (Number of holes where RTHOLEX = (Par for the hole + 2)))/ |
| | Number of completed 18-hole rounds |
| Avg Bogeys | For all completed 18-hole rounds, Avg Bogeys = (Sum (Number |
| | of holes where RTHOLEX = (Par for the hole + 1)))/Number of |
| | completed 18-hole rounds |
| Avg Pars | For all completed 18-hole rounds, Avg Pars = (Sum (Number of |
| | holes where RTHOLEX = (Par for the hole)))/Number of |
| | completed 18-hole rounds |
| Avg Birdies | For all completed 18-hole rounds, Avg Birdies = (Sum (Number |
| | of holes where RTHOLEX = (Par for the hole − 1)))/Number of |
| | completed 18-hole rounds |
| Avg Eagles | For all completed 18-hole rounds, Avg Eagles = (Sum (Number |
| | of holes where RTHOLEX = (Par for the hole − 2)))/Number of |
| | completed 18-hole rounds |
| Percent Triple Bogeys | For all holes played, Percent Triple Bogeys (plus) = ((Sum |
| (Plus) | (Number of holes where RTHOLEX ≧ (Par for the hole + 3)))/ |
| | Number of holes played) * 100 |
| Percent Double Bogeys | For all holes played, Percent Double Bogeys = ((Sum (Number of |
| | holes where RTHOLEX = (Par for the hole + 2)))/Number of |
| | holes played) * 100 |
| Percent Bogeys | For all holes played, Percent Bogeys = ((Sum (Number of holes |
| | where RTHOLEX = (Par for the hole + 1)))/Number of holes |
| | played) * 100 |
| Percent Pars | For all holes played, Percent Pars = ((Sum (Number of holes |
| | where RTHOLEX = (Par for the hole)))/Number of holes |
| | played) * 100 |
| Percent Birdies | For all holes played, Percent Birdies = ((Sum (Number of holes |
| | where RTHOLEX = (Par for the hole − 1)))/Number of holes |
| | played) * 100 |
| Percent Eagles | For all holes played, Percent Eagles = ((Sum (Number of holes |
| | where RTHOLEX = (Par for the hole − 2)))/Number of holes |
| | played) * 100 |
| Number Triple Bogeys | For all holes played, Number Triple Bogeys (plus) = (Sum |
| (Plus) | (Number of holes where RTHOLEX ≧ (Par for the hole + 3))) |
| Number Double Bogeys | For all holes played, Number Double Bogeys = (Sum (Number of |
| | holes where RTHOLEX = (Par for the hole + 2))) |
| Number Bogeys | For all holes played, Number Bogeys = (Sum (Number of holes |
| | where RTHOLEX = (Par for the hole + 1))) |
| Number Pars | For all holes played, Number Pars = (Sum (Number of holes |
| | where RTHOLEX = (Par for the hole))) |
| Number Birdies | For all holes played, Number Birdies = (Sum (Number of holes |
| | where RTHOLEX = (Par for the hole − 1))) |
| Number Eagles | For all holes played, Number Eagles = (Sum (Number of holes |
| | where RTHOLEX = (Par for the hole − 2))) |
| Number Penalty Strokes | For all holes played, Number Penalty Strokes = (Sum |
| | (RPSHOLEX)) |
| Driving Stats: | |
| Avg Distance | For all non-Par 3 holes played, Avg Distance = (Sum (Distance of |
| | each tee shot (RS1HOLEX(3-5)))/Total Number of non-Par 3 |
| | holes played |
| Avg 1W | For all non-Par 3 holes played, Avg 1W = (Sum (Distance of each |
| | 1W tee shot (RS1HOLEX)))/Total Number of 1W tee shots for |
| | all non-Par 3 holes played |
| Avg 3W | For all non-Par 3 holes played, Avg 3W = (Sum (Distance of each |
| | 3W tee shot (RS1HOLEX)))/Total Number of 3W tee shots for |
| | all non-Par 3 holes played |
| Longest Distance | For all non-Par 3 holes played, Longest Distance = Longest of |
| | each tee shot (RS1HOLEX(3-5)) |
| Avg Fairways in Reg | For all completed 18-hole rounds, Avg Fairways in Reg = (Sum |
| | (where RFHOLEX = “C”))/Total Number of completed 18-hole |
| | rounds |
| Avg Fairways Right | For all completed 18-hole rounds, Avg Fairways Right = (Sum |
| | (where RFHOLEX = “R”))/Total Number of completed 18-hole |
| | rounds |
| Avg Fairways Left | For all completed 18-hole rounds, Avg Fairways Left = (Sum |
| | (where RFHOLEX = “L”))/Total Number of completed 18-hole |
| | rounds |
| Percent Fairways in Reg | For all holes played, Percent Fairways in Reg = (Sum (where |
| | RFHOLEX “C”))/Total Number of holes played |
| Percent Fairways 1W | For all holes played, Percent Fairways 1W = (Sum (For each 1W |
| | tee shot (RS1HOLEX) where RFHOLEX = “R”))/Total Number |
| | of holes played |
| Percent Fairways 3W | For all holes played, Percent Fairways 3W = (Sum (For each 3W |
| | tee shot (RS1HOLEX) where RFHOLEX = “L”))/Total Number |
| | of holes played |
| Percent Fairways Left | For all holes played, Percent Fairways Left = (Sum (where |
| | RFHOLEX = “L”))/Total Number of holes played |
| Percent Fairways Right | For all holes played, Percent Fairways Right = (Sum (where |
| | RFHOLEX = “R”))/Total Number of holes played |
| Fairways in Reg | For all holes played, Fairways in Reg = (Sum (where RFHOLEX = |
| | “C”)) |
| Fairways Left | For all holes played, Fairways Left = (Sum (where RFHOLEX = |
| | “R”)) |
| Fairways Right | For all holes played, Fairways Right = (Sum (where RFHOLEX = |
| | “L”)) |
| Approach Game Stats: | |
| Avg Saves | For all completed 18-hole rounds, Avg Saves = (Sum (where |
| | RMHOLEX(1) = 1))/Number of completed 18-hole rounds |
| Avg Sand Saves | For all completed 18-hole rounds, Avg Sand Saves = (Sum |
| | (where RMHOLEX(2) = 1))/Number of completed 18-hole |
| | rounds |
| Avg Up/Downs | For all completed 18-hole rounds, Avg Up/Downs = (Sum (where |
| | RMHOLEX(3) = 1))/Number of completed 18-hole rounds |
| Avg Chip-ins | For all completed 18-hole rounds, Avg Chip-ins = (Sum (where |
| | RMHOLEX(4) = 1))/Number of completed 18-hole rounds |
| Avg Greens in Reg | For all completed 18-hole rounds, Avg Greens in Reg = (Sum |
| | (where RGHOLEX = Y))/Number of completed 18-hole rounds |
| Percent Saves | For all holes played, Percent Saves = (Sum (where |
| | RMHOLEX(1) = 1))/Number of holes played |
| Percent Sand Saves | For all holes played, Percent Sand Saves = (Sum (where |
| | RMHOLEX(2) = 1))/Number of holes played |
| Percent Up/Downs | For all holes played, Percent Up/Downs = (Sum (where |
| | RMHOLEX(3) = 1))/Number of holes played |
| Percent Chip-ins | For all holes played, Percent Chip-ins = (Sum (where |
| | RMHOLEX(4) = 1))/Number of holes played |
| Percent Greens in Reg | For all holes played, Percent Greens in Reg = (Sum (where |
| | RGHOLEX = Y))/Number of holes played |
| Saves | For all holes played, Saves = (Sum (where RMHOLEX(1) = 1)) |
| Sand Saves | For all holes played, Sand Saves = (Sum (where RMHOLEX(2) = |
| | 1)) |
| Up/Downs | For all holes played, Up/Downs = (Sum (where RMHOLEX(3) = |
| | 1)) |
| Chip-ins | For all holes played, Chip-ins = (Sum (where RMHOLEX(4) = 1)) |
| Greens in Reg | For all holes played, Greens in Reg = (Sum (where RGHOLEX = |
| | Y)) |
| Putting Stats: | |
| Avg Putts | For all holes played, Avg Puffs = (Sum (RPHOLEX))/Number |
| | of holes played |
| Avg Putts per Round | For all completed 18-hole rounds, Avg Putts per Round = (Sum |
| | (Avg Putts))/Number of completed 18-hole rounds |
| Avg Putts (Greens in Reg) | For all holes played, Avg Putts (Greens in Reg) = (Sum |
| | (RPHOLEX where RGHOLEX = Y))/Number of holes played |
| | where RGHOLEX = Y |
| Avg One Putts | For all completed 18-hole rounds, Avg One Putts = (Sum |
| | (RPHOLEX where RPHOLEX = 1))/Number of completed 18- |
| | hole rounds |
| Avg Two Putts | For all completed 18-hole rounds, Avg Two Putts = (Sum |
| | (RPHOLEX where RPHOLEX − 2))/Number of completed 18- |
| | hole rounds |
| Avg Three Putts (Plus) | For all completed 18-hole rounds, Avg Three Putts (Plus) = (Sum |
| | (RPHOLEX where RPHOLEX ≧ 3))/Number of completed 18- |
| | hole rounds |
| Percent One Putts | For all holes played, Percent One Putts = (Sum (RPHOLEX |
| | where RPHOLEX = 1))/Number of holes played |
| Percent Two Putts | For all holes played, Percent Two Putts = (Sum (RPHOLEX |
| | where RPHOLEX = 2))/Number of holes played |
| Percent Three Putts (Plus) | For all holes played, Percent Three Putts (Plus) = (Sum |
| | (RPHOLEX where RPHOLEX ≧ 3))/Number of holes played |
| One Putts | For all holes played, One Putts = (Sum (RPHOLEX where |
| | RPHOLEX = 1)) |
| Two Putts | For all holes played, Two Putts = (Sum (RPHOLEX where |
| | RPHOLEX = 2)) |
| Three Putts (Plus) | For all holes played, Three Putts (Plus) = (Sum (RPHOLEX |
| | where RPHOLEX ≧ 3)) |
| Club Stats: | |
| 1W Avg Distance | 1W Avg Distance Sum = (RSNHOLEX (3-5) where |
| | RSNHOLEX (1-2) points to PCLUBX = 1W)/Number of shots |
| | where RSNHOLEX (1-2) points to PCLUBX = 1W |
| 1W Fairway in Reg | 1W Fairway in Reg = Sum (RSNHOLEX (3-5) where |
| | RSNHOLEX (1-2) points to PCLUBX = 1W and RFHOLEX = |
| | “C”)/Number of shots where RSNHOLEX (1-2) points to |
| | PCLUBX = 1W and RFHOLEX = “C” |
| 1W Fairway Right | 1W Fairway Right = Sum (RSNHOLEX (3-5) where |
| | RSNHOLEX (1-2) points to PCLUBX = 1W and RFHOLEX = |
| | “R”)/Number of shots where RSNHOLEX (1-2) points to |
| | PCLUBX = 1W and RFHOLEX = “R” |
| 1W Fairway Left | 1W Fairway Left = Sum (RSNHOLEX (3-5) where RSNHOLEX |
| | (1-2) points to PCLUBX = 1W and RFHOLEX = “L”)/Number |
| | of shots where RSNHOLEX (1-2) points to PCLUBX = 1W and |
| | RFHOLEX = “L” |
| 3W Avg Distance | 3W Avg Distance = Sum (RSNHOLEX (3-5) where |
| | RSNHOLEX (1-2) points to PCLUBX = 3W)/Number of shots |
| | where RSNHOLEX (1-2) points to PCLUBX = 3W |
| 3W Fairway in Reg | 3W Fairway in Reg = Sum (RSNHOLEX (3-5) where |
| | RSNHOLEX (1-2) points to PCLUBX = 3W and RFHOLEX = |
| | “C”)/Number of shots where RSNHOLEX (1-2) points to |
| | PCLUBX = 3W and RFHOLEX = “C” |
| 3W Fairway Right | 3W Fairway Right = Sum (RSNHOLEX (3-5) where |
| | RSNHOLEX (1-2) points to PCLUBX = 3W and RFHOLEX = |
| | “R”)/Number of shots where RSNHOLEX (1-2) points to |
| | PCLUBX = 3W and RFHOLEX = “R” |
| 3W Fairway Left | 3W Fairway Left = Sum (RSNHOLEX (3-5) where RSNHOLEX |
| | (1-2) points to PCLUBX = 3W and RFHOLEX = “L”)/Number |
| | of shots where RSNHOLEX (1-2) points to PCLUBX = 3W and |
| | RFHOLEX = “L” |
| 5W Avg Distance | 5W Avg Distance = Sum (RSNHOLEX (3-5) where |
| | RSNHOLEX (1-2) points to PCLUBX = 5W)/Number of shots |
| | where RSNHOLEX (1-2) points to PCLUBX = 5W |
| 3 Avg Distance | 3 Avg Distance = Sum (RSNHOLEX (3-5) where RSNHOLEX |
| | (1-2) points to PCLUBX = 3)/Number of shots where |
| | RSNHOLEX (1-2) points to PCLUBX = 3 |
| 4 Avg Distance | 4 Avg Distance = Sum (RSNHOLEX (3-5) where RSNHOLEX |
| | (1-2) points to PCLUBX = 4)/Number of shots where |
| | RSNHOLEX (1-2) points to PCLUBX = 4 |
| 5 Avg Distance | 5 Avg Distance = Sum (RSNHOLEX (3-5) where RSNHOLEX |
| | (1-2) points to PCLUBX = 5)/Number of shots where |
| | RSNHOLEX (1-2) points to PCLUBX = 5 |
| 6 Avg Distance | 6 Avg Distance = Sum (RSNHOLEX (3-5) where RSNHOLEX |
| | (1-2) points to PCLUBX = 6)/Number of shots where |
| | RSNHOLEX (1-2) points to PCLUBX = 6 |
| 7 Avg Distance | 7 Avg Distance = Sum (RSNHOLEX (3-5) where RSNHOLEX |
| | (1-2) points to PCLUBX = 7)/Number of shots where |
| | RSNHOLEX (1-2) points to PCLUBX = 7 |
| 8 Avg Distance | 8 Avg Distance = Sum (RSNHOLEX (3-5) where RSNHOLEX |
| | (1-2) points to PCLUBX = 8)/Number of shots where |
| | RSNHOLEX (1-2) points to PCLUBX = 8 |
| 9 Avg Distance | 9 Avg Distance = Sum (RSNHOLEX (3-5) where RSNHOLEX |
| | (1-2) points to PCLUBX = 9)/Number of shots where |
| | RSNHOLEX (1-2) points to PCLUBX = 9 |

TABLE 2
Formulas Database Description

| General Statistics | Formula/Method of Calculation |
|---|---|
| | Note: For 9-hole statistics, a completed 9 holes means the player |
| | completes holes 1-9 or 10-18. This means a player could |
| | complete 9 holes by playing only 9 holes of an 18 hole course, |
| | leaving an incomplete 18 hole round . . . or the player could play a |
| | full 18 holes which would give him two (2) completed 9 holes. |
| | For example, if a player plays holes 3-11, this does not count as a |
| | completed 9 holes. |
| Low 18 | For all completed rounds (18 holes) played for this player, take |
| | the round with the lowest total score RPSCOREG |
| High 18 | For all completed rounds (18 holes) played for this player, take |
| | the round with the highest total score RPSCOREG |
| Low 9 | For all completed 9 holes played for this player, take the lowest |
| | total score RPSCOREG |
| High 9 | For all completed 9 holes played for this player, take the highest |
| | total score RPSCOREG |
| Avg 18 | For all completed rounds (18 holes) played for this player, Avg |
| | 18 = (Sum of all scores RPSCOREG)/Number of Completed |
| | Rounds |
| Avg 9 | For all completed 9 holes played for this player, Avg 9 = (Sum of |
| | all scores RPSCOREG)/Number of Completed 9 holes |
| Performance Statistics | Note: Performance Statistics are prepared for ALL holes, all |
| | PAR 3 holes, all PAR 4 holes, and all PAR 5 holes. So, as you |
| | review the formulas you must consider this. For example, the |
| | ALL category includes all holes played, or in the case of averages |
| | 18 holes . . . whereas, the Par 3 statistics would consider only par 3 |
| | holes played (either among all holes or among 18 holes in the |
| | case of averages). So, when you are summing, in all cases except |
| | ALL, you must check for the par rating for the hole to determine |
| | if a particular hole should be included in the calculation. |
| Avg Score | For all completed 18-hole rounds, Avg Score = (Sum of all scores |
| | RPSCOREG)/Number of completed 18-hole rounds |
| Avg Over/Under | For all completed 18-hole rounds, Avg Over/Under = (Sum of all |
| | (Total Par for the Course and tees played − RPSCOREG))/ |
| | Number of completed 18-hole rounds |
| Avg Triple Bogeys (plus) | For all completed 18-hole rounds, Avg Triple Bogeys (plus) = |
| | (Sum (Number of holes where RTHOLEX ≧ (Par for the hole + |
| | 3)))/Number of completed 18-hole rounds |
| Avg Double Bogeys | For all completed 18-hole rounds, Avg Double Bogeys = (Sum |
| | (Number of holes where RTHOLEX = (Par for the hole + 2)))/ |
| | Number of completed 18-hole rounds |
| Avg Bogeys | For all completed 18-hole rounds, Avg Bogeys = (Sum (Number |
| | of holes where RTHOLEX = (Par for the hole + 1)))/Number of |
| | completed 18-hole rounds |
| Avg Pars | For all completed 18-hole rounds, Avg Pars = (Sum (Number of |
| | holes where RTHOLEX = (Par for the hole)))/Number of |
| | completed 18-hole rounds |
| Avg Birdies | For all completed 18-hole rounds, Avg Birdies = (Sum (Number |
| | of holes where RTHOLEX = (Par for the hole − 1)))/Number of |
| | completed 18-hole rounds |
| Avg Eagles | For all completed 18-hole rounds, Avg Eagles = (Sum (Number |
| | of holes where RTHOLEX = (Par for the hole − 2)))/Number of |
| | completed 18-hole rounds |
| Percent Triple Bogeys | For all holes played, Percent Triple Bogeys (plus) = ((Sum |
| (Plus) | (Number of holes where RTHOLEX ≧ (Par for the hole + 3)))/ |
| | Number of holes played) * 100 |
| Percent Double Bogeys | For all holes played, Percent Double Bogeys = ((Sum (Number of |
| | holes where RTHOLEX = (Par for the hole + 2)))/Number of |
| | holes played) * 100 |
| Percent Bogeys | For all holes played, Percent Bogeys = ((Sum (Number of holes |
| | where RTHOLEX = (Par for the hole + 1)))/Number of holes |
| | played) * 100 |
| Percent Pars | For all holes played, Percent Pars = ((Sum (Number of holes |
| | where RTHOLEX = (Par for the hole)))/Number of holes |
| | played) * 100 |
| Percent Birdies | For all holes played, Percent Birdies = ((Sum (Number of holes |
| | where RTHOLEX = (Par for the hole − 1)))/Number of holes |
| | played) * 100 |
| Percent Eagles | For all holes played, Percent Eagles = ((Sum (Number of holes |
| | where RTHOLEX = (Par for the hole − 2)))/Number of holes |
| | played) * 100 |
| Number Triple Bogeys | For all holes played, Number Triple Bogeys (plus) = (Sum |
| (Plus) | (Number of holes where RTHOLEX ≧ (Par for the hole + 3))) |
| Number Double Bogeys | For all holes played, Number Double Bogeys = (Sum (Number of |
| | holes where RTHOLEX = (Par for the hole + 2))) |
| Number Bogeys | For all holes played, Number Bogeys = (Sum (Number of holes |
| | where RTHOLEX = (Par for the hole + 1))) |
| Number Pars | For all holes played, Number Pars = (Sum (Number of holes |
| | where RTHOLEX = (Par for the hole))) |
| Number Birdies | For all holes played, Number Birdies = (Sum (Number of holes |
| | where RTHOLEX = (Par for the hole − 1))) |
| Number Eagles | For all holes played, Number Eagles = (Sum (Number of holes |
| | where RTHOLEX = (Par for the hole − 2))) |
| Number Penalty Strokes | For all holes played, Number Penalty Strokes = (Sum |
| | (RPSHOLEX)) |
| Driving Stats: | |
| Avg Distance | For all non-Par 3 holes played, Avg Distance = (Sum (Distance of |
| | each tee shot (RS1HOLEX (3-5)))/Total Number of non-Par 3 |
| | holes played |
| Avg 1W | For all non-Par 3 holes played, Avg 1W = (Sum (Distance of each |
| | 1W tee shot (RS1HOLEX)))/Total Number of 1W tee shots for |
| | all non-Par 3 holes played |
| Avg 3W | For all non-Par 3 holes played, Avg 3W = (Sum (Distance of each |
| | 3W tee shot (RS1HOLEX)))/Total Number of 3W tee shots for |
| | all non-Par 3 holes played |
| Longest Distance | For all non-Par 3 holes played, Longest Distance = Longest of |
| | each tee shot (RS1HOLEX (3-5)) |
| Avg Fairways in Reg | For all completed 18-hole rounds, Avg Fairways in Reg = (Sum |
| | (where RFHOLEX = “C”))/Total Number of completed 18-hole |
| | rounds |
| Avg Fairways Right | For all completed 18-hole rounds, Avg Fairways Right = (Sum |
| | (where RFHOLEX = “R”))/Total Number of completed 18-hole |
| | rounds |
| Avg Fairways Left | For all completed 18-hole rounds, Avg Fairways Left = (Sum |
| | (where RFHOLEX = “L”))/Total Number of completed 18-hole |
| | rounds |
| Percent Fairways in Reg | For all holes played, Percent Fairways in Reg = (Sum (where |
| | RFHOLEX = “C”))/Total Number of holes played |
| Percent Fairways 1W | For all holes played, Percent Fairways 1W = (Sum (For each 1W |
| | tee shot (RS1HOLEX) where RFHOLEX = “R”))/Total Number |
| | of holes played |
| Percent Fairways 3W | For all holes played, Percent Fairways 3W = (Sum (For each 3W |
| | tee shot (RS1HOLEX) where RFHOLEX = “L”))/Total Number |
| | of holes played |
| Percent Fairways Left | For all holes played, Percent Fairways Left = (Sum (where |
| | RFHOLEX = “L”))/Total Number of holes played |
| Percent Fairways Right | For all holes played, Percent Fairways Right = (Sum (where |
| | RFHOLEX = “R”))/Total Number of holes played |
| Fairways in Reg | For all holes played, Fairways in Reg = (Sum (where REHOLEX = |
| | “C”)) |
| Fairways Left | For all holes played, Fairways Left = (Sum (where RFHOLEX = |
| | “R”)) |
| Fairways Right | For all holes played, Fairways Right = (Sum (where RFHOLEX = |
| | “L”)) |
| Approach Game Stats: | |
| Avg Saves | For all completed 18-hole rounds, Avg Saves = (Sum (where |
| | RMHOLEX (1) = 1))/Number of completed 18-hole rounds |
| Avg Sand Saves | For all completed 18-hole rounds, Avg Sand Saves = (Sum |
| | (where RMHOLEX (2) = 1))/Number of completed 18-hole |
| | rounds |
| Avg Up/Downs | For all completed 18-hole rounds, Avg Up/Downs = (Sum (where |
| | RMHOLEX (3) = 1))/Number of completed 18-hole rounds |
| Avg Chip-ins | For all completed 18-hole rounds, Avg Chip-ins = (Sum (where |
| | RMHOLEX (4) = 1))/Number of completed 18-hole rounds |
| Avg Greens in Reg | For all completed 18-hole rounds, Avg Greens in Reg = (Sum |
| | (where RGHOLEX = Y))/Number of completed 18-hole rounds |
| Percent Saves | For all holes played, Percent Saves = (Sum (where RMHOLEX |
| | (1) = 1))/Number of holes played |
| Percent Sand Saves | For all holes played, Percent Sand Saves = (Sum (where |
| | RMHOLEX (2) = 1))/Number of holes played |
| Percent Up/Downs | For all holes played, Percent Up/Downs = (Sum (where |
| | RMHOLEX (3) = 1))/Number of holes played |
| Percent Chip-ins | For all holes played, Percent Chip-ins = (Sum (where |
| | RMHOLEX (4) = 1))/Number of holes played |
| Percent Greens in Reg | For all holes played, Percent Greens in Reg = (Sum (where |
| | RGHOLEX = Y))/Number of holes played |
| Saves | For all holes played, Saves = (Sum (where RMHOLEX (1) = 1)) |
| Sand Saves | For all holes played, Sand Saves = (Sum (where RMHOLEX (2) = |
| | 1)) |
| Up/Downs | For all holes played, Up/Downs = (Sum (where RMHOLEX (3) = |
| | 1)) |
| Chip-ins | For all holes played, Chip-ins = (Sum (where RMHOLEX (4) = |
| | 1)) |
| Greens in Reg | For all holes played, Greens in Reg = (Sum (where RGHOLEX = |
| | Y)) |
| Putting Stats: | |
| Avg Putts | For all holes played, Avg Putts = (Sum (RPHOLEX))/Number |
| | of holes played |
| Avg Putts per Round | For all completed 18-hole rounds, Avg Putts per Round = (Sum |
| | (Avg Putts))/Number of completed 18-hole rounds |
| Avg Putts (Greens in Reg) | For all holes played, Avg Putts (Greens in Reg) = (Sum |
| | (RPHOLEX where RGHOLEX = Y))/Number of holes played |
| | where RGHOLEX = Y |
| Avg One Putts | For all completed 18-hole rounds, Avg One Putts = (Sum |
| | (RPHOLEX where RPHOLEX = 1))/Number of completed 18- |
| | hole rounds |
| Avg Two Putts | For all completed 18-hole rounds, Avg Two Putts = (Sum |
| | (RPHOLEX where RPHOLEX = 2))/Number of completed 18- |
| | hole rounds |
| Avg Three Putts (Plus) | For all completed 18-hole rounds, Avg Three Putts (Plus) = (Sum |
| | (RPHOLEX where RPHOLEX ≧ 3))/Number of completed 18- |
| | hole rounds |
| Percent One Putts | For all holes played, Percent One Putts = (Sum (RPHOLEX |
| | where RPHOLEX = 1))/Number of holes played |
| Percent Two Putts | For all holes played, Percent Two Putts = (Sum (RPHOLEX |
| | where RPHOLEX = 2))/Number of holes played |
| Percent Three Putts (Plus) | For all holes played, Percent Three Putts (Plus) = (Sum |
| | (RPHOLEX where RPHOLEX ≧ 3))/Number of holes played |
| One Putts | For all holes played, One Putts = (Sum (RPHOLEX where |
| | RPHOLEX = 1)) |
| Two Putts | For all holes played, Two Putts = (Sum (RPHOLEX where |
| | RPHOLEX = 2)) |
| Three Putts (Plus) | For all holes played, Three Putts (Plus) = (Sum (RPHOLEX |
| | where RPHOLEX ≧ 3)) |
| Club Stats: | |
| 1W Avg Distance | 1W Avg Distance Sum = (RSNHOLEX (3-5) where RSNHOLEX |
| | (1-2) points to PCLUBX = 1W)/Number of shots where |
| | RSNHOLEX (1-2) points to PCLUBX = 1W |
| 1W Fairway in Reg | 1W Fairway in Reg = Sum (RSNHOLEX (3-5) where |
| | RSNHOLEX (1-2) points to PCLUBX = 1W and RFHOLEX = |
| | “C”)/Number of shots where RSNHOLEX (1-2) points to |
| | PCLUBX = 1W and RFHOLEX = “C” |
| 1W Fairway Right | 1W Fairway Right = Sum (RSNHOLEX (3-5) where |
| | RSNHOLEX (1-2) points to PCLUBX = 1W and RFHOLEX = |
| | “R”)/Number of shots where RSNHOLEX (1-2) points to |
| | PCLUBX = 1W and RFHOLEX = “R” |
| 1W Fairway Left | 1W Fairway Left = Sum (RSNHOLEX (3-5) where RSNHOLEX |
| | (1-2) points to PCLUBX = 1W and RFHOLEX = “L”)/Number |
| | of shots where RSNHOLEX (1-2) points to PCLUBX = 1W and |
| | RFHOLEX = “L” |
| 3W Avg Distance | 3W Avg Distance = Sum (RSNHOLEX (3-5) where RSNHOLEX |
| | (1-2) points to PCLUBX = 3W)/Number of shots where |
| | RSNHOLEX (1-2) points to PCLUBX = 3W |
| 3W Fairway in Reg | 3W Fairway in Reg = Sum (RSNHOLEX (3-5) where |
| | RSNHOLEX (1-2) points to PCLUBX = 3W and RFHOLEX = |
| | “C”)/Number of shots where RSNHOLEX (1-2) points to |
| | PCLUBX = 3W and RFHOLEX = “C” |
| 3W Fairway Right | 3W Fairway Right = Sum (RSNHOLEX (3-5) where |
| | RSNHOLEX (1-2) points to PCLUBX = 3W and RFHOLEX = |
| | “R”)/Number of shots where RSNHOLEX (1-2) points to |
| | PCLUBX = 3W and RFHOLEX = “R” |
| 3W Fairway Left | 3W Fairway Left = Sum (RSNHOLEX (3-5) where RSNHOLEX |
| | (1-2) points to PCLUBX = 3W and RFHOLEX = “L”)/Number |
| | of shots where RSNHOLEX (1-2) points to PCLUBX = 3W and |
| | RFHOLEX = “L” |
| 5W Avg Distance | 5W Avg Distance = Sum (RSNHOLEX (3-5) where RSNHOLEX |
| | (1-2) points to PCLUBX = 5W)/Number of shots where |
| | RSNHOLEX (1-2) points to PCLUBX = 5W |
| 3 Avg Distance | 3 Avg Distance = Sum (RSNHOLEX (3-5) where RSNHOLEX |
| | (1-2) points to PCLUBX = 3)/Number of shots where |
| | RSNHOLEX (1-2) points to PCLUBX = 3 |
| 4 Avg Distance | 4 Avg Distance = Sum (RSNHOLEX (3-5) where RSNHOLEX |
| | (1-2) points to PCLUBX = 4)/Number of shots where |
| | RSNHOLEX (1-2) points to PCLUBX = 4 |
| 5 Avg Distance | 5 Avg Distance = Sum (RSNHOLEX (3-5) where RSNHOLEX |
| | (1-2) points to PCLUBX = 5)/Number of shots where |
| | RSNHOLEX (1-2) points to PCLUBX = 5 |
| 6 Avg Distance | 6 Avg Distance = Sum (RSNHOLEX (3-5) where RSNHOLEX |
| | (1-2) points to PCLUBX = 6)/Number of shots where |
| | RSNHOLEX (1-2) points to PCLUBX = 6 |
| 7 Avg Distance | 7 Avg Distance = Sum (RSNHOLEX (3-5) where RSNHOLEX |
| | (1-2) points to PCLUBX = 7)/Number of shots where |
| | RSNHOLEX (1-2) points to PCLUBX = 7 |
| 8 Avg Distance | 8 Avg Distance = Sum (RSNHOLEX (3-5) where RSNHOLEX |
| | (1-2) points to PCLUBX = 8)/Number of shots where |
| | RSNHOLEX (1-2) points to PCLUBX = 8 |
| 9 Avg Distance | 9 Avg Distance = Sum (RSNHOLEX (3-5) where RSNHOLEX |
| | (1-2) points to PCLUBX = 9)/Number of shots where |
| | RSNHOLEX (1-2) points to PCLUBX = 9 |

TABLE 3
Player Database Description

| | Data | | |
|---|---|---|---|
| Data Name | Type | Length | Description |
| General Info | | | |
| PNAMEF | CHAR | 20 | Player's first name |
| PNAMEL | CHAR | 20 | Player's last name |
| PNUMB | NUM | 4 | Player's unique ID number to associate |
| | | | with rounds |
| PLFTRGT | CHAR | 1 | Indicates whether player is right-handed |
| | | | or left-handed. |
| | | | R = right, L = left |
| PCLUB1 | CHAR | 2 | Player Club1 - Default “1W” |
| PCLUB2 | CHAR | 2 | Player Club2 - Default “3W” |
| PCLUB3 | CHAR | 2 | Player Club3 - Default “5W” |
| PCLUB4 | CHAR | 2 | Player Club4 - Default “3” |
| PCLUB5 | CHAR | 2 | Player Club5 - Default “4” |
| PCLUB6 | CHAR | 2 | Player Club6 - Default “5” |
| PCLUB7 | CHAR | 2 | Player Club7 - Default “6” |
| PCLUB8 | CHAR | 2 | Player Club8 - Default “7” |
| PCLUB9 | CHAR | 2 | Player Club9 - Default “8” |
| PCLUB10 | CHAR | 2 | Player Club10 - Default “9” |
| PCLUB11 | CHAR | 2 | Player Club11 - Default “PW” |
| PCLUB12 | CHAR | 2 | Player Club12 - Default “SW” |
| PCLUB13 | CHAR | 2 | Player Club13 - Default “P” |
| PCLUB14 | CHAR | 2 | Player Club14 - Default“” |
| PCLUB15 | CHAR | 2 | Player Club15 - Default“” |
| PCLUB16 | CHAR | 2 | Player Club16 - Default“” |
| PDIST1 | NUM | 3 | Average distance for player's Club1 |
| PDIST2 | NUM | 3 | Average distance for player's Club2 |
| PDIST3 | NUM | 3 | Average distance for player's Club3 |
| PDIST4 | NUM | 3 | Average distance for player's Club4 |
| PDIST5 | NUM | 3 | Average distance for player's Club5 |
| PDIST6 | NUM | 3 | Average distance for player's Club6 |
| PDIST7 | NUM | 3 | Average distance for player's Club7 |
| PDIST8 | NUM | 3 | Average distance for player's Club8 |
| PDIST9 | NUM | 3 | Average distance for player's Club9 |
| PDIST10 | NUM | 3 | Average distance for player's Club10 |
| PDIST11 | NUM | 3 | Average distance for player's Club11 |
| PDIST12 | NUM | 3 | Average distance for player's Club12 |
| PDIST13 | NUM | 3 | Average distance for player's Club13 |
| PDIST14 | NUM | 3 | Average distance for player's Club14 |
| PDIST15 | NUM | 3 | Average distance for player's Club15 |
| PDIST16 | NUM | 3 | Average distance for player's Club16 |
| Score Stats | | | Average distance for player's Club17 |
| PHCP | NUM | 3, 1 | Player Handicap - See handicap formula |
| | | | at Tab X |

TABLE 4
Golf Courses Database Description

| | Data | | |
|---|---|---|---|
| Data Name | Type | Length | Description |
| CNAME | CHAR | 25 | Course Name |
| CNUMB | NUM | 4 | Unique number identifying this course |
| CCITY | CHAR | 25 | City where course is located |
| CSTATE | CHAR | 2 | 2 letter abbreviation for state where course is located |
| CPRO | CHAR | 30 | Name of club pro |
| CPHONE | NUM | 10 | Course phone number |
| CTNAME1 | CHAR | 10 | Name of this set of tees |
| CTNAME2 | CHAR | 10 | Name of this set of tees |
| CTNAME3 | CHAR | 10 | Name of this set of tees |
| CTNAME4 | CHAR | 10 | Name of this set of tees |
| CTNAME5 | CHAR | 10 | Name of this set of tees |
| CTNAME6 | CHAR | 10 | Name of this set of tees |
| CTRTG1 | DEC | 3, 1 | Rating from this set of tees |
| CTRTG2 | DEC | 3, 1 | Rating from this set of tees |
| CTRTG3 | DEC | 3, 1 | Rating from this set of tees |
| CTRTG4 | DEC | 3, 1 | Rating from this set of tees |
| CTRTG5 | DEC | 3, 1 | Rating from this set of tees |
| CTRTG6 | DEC | 3, 1 | Rating from this set of tees |
| CSLOPE1 | NUM | 3 | Slope from this set of tees |
| CSLOPE2 | NUM | 3 | Slope from this set of tees |
| CSLOPE3 | NUM | 3 | Slope from this set of tees |
| CSLOPE4 | NUM | 3 | Slope from this set of tees |
| CSLOPE5 | NUM | 3 | Slope from this set of tees |
| CSLOPE6 | NUM | 3 | Slope from this set of tees |
| CT1PHY1 | NUM | 6 | Par, handicap, and yardage for this tee (e.g., PHHYYY, where |
| | | | P = 1-5, HH = 01-18, YYY = 001-999) |
| CT1PHY2 | NUM | 6 | Par, handicap, and yardage for this tee (e.g., PHHYYY, where |
| | | | P = 1-5, HH = 01-18, YYY = 001-999) |
| CT1PHY3 | NUM | 6 | Par, handicap, and yardage for this tee (e.g., PHHYYY, where |
| | | | P = 1-5, HH = 01-18, YYY = 001-999) |
| CT1PHY4 | NUM | 6 | Par, handicap, and yardage for this tee (e.g., PHHYYY, where |
| | | | P = 1-5, HH = 01-18, YYY = 001-999) |
| CTIPHY5 | NUM | 6 | Par, handicap, and yardage for this tee (e.g., PHHYYY, where |
| | | | P = 1-5, HH = 01-18, YYY = 001-999) |
| CT1PHY6 | NUM | 6 | Par, handicap, and yardage for this tee (e.g., PHHYYY, where |
| | | | P = 1-5, HH = 01-18, YYY = 001-999) |
| CT1PHY7 | NUM | 6 | Par, handicap, and yardage for this tee (e.g., PHHYYY, where |
| | | | P = 1-5, HH = 01-18, YYY = 001-999) |
| CT1PHY8 | NUM | 6 | Par, handicap, and yardage for this tee (e.g., PHHYYY, where |
| | | | P = 1-5, HH = 01-18, YYY = 001-999) |
| CT1PHY9 | NUM | 6 | Par, handicap, and yardage for this tee (e.g., PHHYYY, where |
| | | | P = 1-5, HH = 01-18, YYY = 001-999) |
| CT1PHY10 | NUM | 6 | Par, handicap, and yardage for this tee (e.g., PHHYYY, where |
| | | | P = 1-5, HH = 01-18, YYY = 001-999) |
| CT1PHY11 | NUM | 6 | Par, handicap, and yardage for this tee (e.g., PHHYYY, where |
| | | | P = 1-5, HH = 01-18, YYY = 001-999) |
| CT1PHY12 | NUM | 6 | Par, handicap, and yardage for this tee (e.g., PHHYYY, where |
| | | | P = 1-5, HH = 01-18, YYY = 001-999) |
| CT1PHY13 | NUM | 6 | Par, handicap, and yardage for this tee (e.g., PHHYYY, where |
| | | | P = 1-5, HH = 01-18, YYY = 001-999) |
| CT1PHY14 | NUM | 6 | Par, handicap, and yardage for this tee (e.g., PHHYYY, where |
| | | | P = 1-5, HH = 01-18, YYY = 001-999) |
| CT1PHY15 | NUM | 6 | Par, handicap, and yardage for this tee (e.g., PHHYYY, where |
| | | | P = 1-5, HH = 01-18, YYY = 001-999) |
| CT1PHY16 | NUM | 6 | Par, handicap, and yardage for this tee (e.g., PHHYYY, where |
| | | | P = 1-5, HH = 01-18, YYY = 001-999) |
| CT1PHY17 | NUM | 6 | Par, handicap, and yardage for this tee (e.g., PHHYYY, where |
| | | | P = 1-5, HH = 01-18, YYY = 001-999) |
| CT1PHY18 | NUM | 6 | Par, handicap, and yardage for this tee (e.g., PHHYYY, where |
| | | | P = 1-5, HH = 01-18, YYY = 001-999) |
| CT2PHY1 | NUM | 6 | Par, handicap, and yardage for this tee (e.g., PHHYYY, where |
| | | | P = 1-5, HH = 01-18, YYY = 001-999) |
| CT2PHY2 | NUM | 6 | Par, handicap, and yardage for this tee (e.g., PHHYYY, where |
| | | | P = 1-5, HH = 01-18, YYY = 001-999) |
| CT2PHY3 | NUM | 6 | Par, handicap, and yardage for this tee (e.g., PHHYYY, where |
| | | | P = 1-5, HH = 01-18, YYY = 001-999) |
| CT2PHY4 | NUM | 6 | Par, handicap, and yardage for this tee (e.g., PHHYYY, where |
| | | | P = 1-5, HH = 01-18, YYY = 001-999) |
| CT2PHY5 | NUM | 6 | Par, handicap, and yardage for this tee (e.g., PHHYYY, where |
| | | | P = 1-5, HH = 01-18, YYY = 001-999) |
| CT2PHY6 | NUM | 6 | Par, handicap, and yardage for this tee (e.g., PHHYYY, where |
| | | | P = 1-5, HH = 01-18, YYY = 001-999) |
| CT2PHY7 | NUM | 6 | Par, handicap, and yardage for this tee (e.g., PHHYYY, where |
| | | | P = 1-5, HH = 01-18, YYY = 001-999) |
| CT2PHY8 | NUM | 6 | Par, handicap, and yardage for this tee (e.g., PHHYYY, where |
| | | | P = 1-5, HH = 01-18, YYY = 001-999) |
| CT2PHY9 | NUM | 6 | Par, handicap, and yardage for this tee (e.g., PHHYYY, where |
| | | | P = 1-5, HH = 01-18, YYY = 001-999) |
| CT2PHY10 | NUM | 6 | Par, handicap, and yardage for this tee (e.g., PHHYYY, where |
| | | | P = 1-5, HH = 01-18, YYY = 001-999) |
| CT2PHY11 | NUM | 6 | Par, handicap, and yardage for this tee (e.g., PHHYYY, where |
| | | | P = 1-5, HH = 01-18, YYY = 001-999) |
| CT2PHY12 | NUM | 6 | Par, handicap, and yardage for this tee (e.g., PHHYYY, where |
| | | | P = 1-5, HH = 01-18, YYY = 001-999) |
| CT2PHY13 | NUM | 6 | Par, handicap, and yardage for this tee (e.g., PHHYYY, where |
| | | | P = 1-5, HH = 01-18, YYY = 001-999) |
| CT2PHY14 | NUM | 6 | Par, handicap, and yardage for this tee (e.g., PHHYYY, where |
| | | | P = 1-5, HH = 01-18, YYY = 001-999) |
| CT2PHY15 | NUM | 6 | Par, handicap, and yardage for this tee (e.g., PHHYYY, where |
| | | | P = 1-5, HH = 01-18, YYY = 001-999) |
| CT2PHY16 | NUM | 6 | Par, handicap, and yardage for this tee (e.g., PHHYYY, where |
| | | | P = 1-5, HH = 01-18, YYY = 001-999) |
| CT2PHY17 | NUM | 6 | Par, handicap, and yardage for this tee (e.g., PHHYYY, where |
| | | | P = 1-5, HH = 01-18, YYY = 001-999) |
| CT2PHY18 | NUM | 6 | Par, handicap, and yardage for this tee (e.g., PHHYYY, where |
| | | | P = 1-5, HH = 01-18, YYY = 001-999) |
| CT3PHY1 | NUM | 6 | Par, handicap, and yardage for this tee (e.g., PHHYYY, where |
| | | | P = 1-5, HH = 01-18, YYY = 001-999) |
| CT3PHY2 | NUM | 6 | Par, handicap, and yardage for this tee (e.g., PHHYYY, where |
| | | | P = 1-5, HH = 01-18, YYY = 001-999) |
| CT3PHY3 | NUM | 6 | Par, handicap, and yardage for this tee (e.g., PHHYYY, where |
| | | | P = 1-5, HH = 01-18, YYY = 001-999) |
| CT3PHY4 | NUM | 6 | Par, handicap, and yardage for this tee (e.g., PHHYYY, where |
| | | | P = 1-5, HH = 01-18, YYY = 001-999) |
| CT3PHY5 | NUM | 6 | Par, handicap, and yardage for this tee (e.g., PHHYYY, where |
| | | | P = 1-5, HH = 01-18, YYY = 001-999) |
| CT3PHY6 | NUM | 6 | Par, handicap, and yardage for this tee (e.g., PHHYYY, where |
| | | | P = 1-5, HH = 01-18, YYY = 001-999) |
| CT3PHY7 | NUM | 6 | Par, handicap, and yardage for this tee (e.g., PHHYYY, where |
| | | | P = 1-5, HH = 01-18, YYY = 001-999) |
| CT3PHY8 | NUM | 6 | Par, handicap, and yardage for this tee (e.g., PHHYYY, where |
| | | | P = 1-5, HH = 01-18, YYY = 001-999) |
| CT3PHY9 | NUM | 6 | Par, handicap, and yardage for this tee (e.g., PHHYYY, where |
| | | | P = 1-5, HH = 01-18, YYY = 001-999) |
| CT3PHY10 | NUM | 6 | Par, handicap, and yardage for this tee (e.g., PHHYYY, where |
| | | | P = 1-5, HH = 01-18, YYY = 001-999) |
| CT3PHY11 | NUM | 6 | Par, handicap, and yardage for this tee (e.g., PHHYYY, where |
| | | | P = 1-5, HH = 01-18, YYY = 001-999) |
| CT3PHY12 | NUM | 6 | Par, handicap, and yardage for this tee (e.g., PHHYYY, where |
| | | | P = 1-5, HH = 01-18, YYY = 001-999) |
| CT3PHY13 | NUM | 6 | Par, handicap, and yardage for this tee (e.g., PHHYYY, where |
| | | | P = 1-5, HH = 01-18, YYY = 001-999) |
| CT3PHY14 | NUM | 6 | Par, handicap, and yardage for this tee (e.g., PHHYYY, where |
| | | | P = 1-5, HH = 01-18, YYY = 001-999) |
| CT3PHY15 | NUM | 6 | Par, handicap, and yardage for this tee (e.g., PHHYYY, where |
| | | | P = 1-5, HH = 01-18, YYY = 001-999) |
| CT3PHY16 | NUM | 6 | Par, handicap, and yardage for this tee (e.g., PHHYYY, where |
| | | | P = 1-5, HH = 01-18, YYY = 001-999) |
| CT3PHY17 | NUM | 6 | Par, handicap, and yardage for this tee (e.g., PHHYYY, where |
| | | | P = 1-5, HH = 01-18, YYY = 001-999) |
| CT3PHY18 | NUM | 6 | Par, handicap, and yardage for this tee (e.g., PHHYYY, where |
| | | | P = 1-5, HH = 01-18, YYY = 001-999) |
| CT4PHY1 | NUM | 6 | Par, handicap, and yardage for this tee (e.g., PHHYYY, where |
| | | | P = 1-5, HH = 01-18, YYY = 001-999) |
| CT4PHY2 | NUM | 6 | Par, handicap, and yardage for this tee (e.g., PHHYYY, where |
| | | | P = 1-5, HH = 01-18, YYY = 001-999) |
| CT4PHY3 | NUM | 6 | Par, handicap, and yardage for this tee (e.g., PHHYYY, where |
| | | | P = 1-5, HH = 01-18, YYY = 001-999) |
| CT4PHY4 | NUM | 6 | Par, handicap, and yardage for this tee (e.g., PHHYYY, where |
| | | | P = 1-5, HH = 01-18, YYY = 001-999) |
| CT4PHY5 | NUM | 6 | Par, handicap, and yardage for this tee (e.g., PHHYYY, where |
| | | | P = 1-5, HH = 01-18, YYY = 001-999) |
| CT4PHY6 | NUM | 6 | Par, handicap, and yardage for this tee (e.g., PHHYYY, where |
| | | | P = 1-5, HH = 01-18, YYY = 001-999) |
| CT4PHY7 | NUM | 6 | Par, handicap, and yardage for this tee (e.g., PHHYYY, where |
| | | | P = 1-5, HH = 01-18, YYY = 001-999) |
| CT4PHY8 | NUM | 6 | Par, handicap, and yardage for this tee (e.g., PHHYYY, where |
| | | | P = 1-5, HH = 01-18, YYY = 001-999) |
| CT4PHY9 | NUM | 6 | Par, handicap, and yardage for this tee (e.g., PHHYYY, where |
| | | | P = 1-5, HH = 01-18, YYY = 001-999) |
| CT4PHY10 | NUM | 6 | Par, handicap, and yardage for this tee (e.g., PHHYYY, where |
| | | | P = 1-5, HH = 01-18, YYY = 001-999) |
| CT4PHY11 | NUM | 6 | Par, handicap, and yardage for this tee (e.g., PHHYYY, where |
| | | | P = 1-5, HH = 01-18, YYY = 001-999) |
| CT4PHY12 | NUM | 6 | Par, handicap, and yardage for this tee (e.g., PHHYYY, where |
| | | | P = 1-5, HH = 01-18, YYY = 001-999) |
| CT4PHY13 | NUM | 6 | Par, handicap, and yardage for this tee (e.g., PHHYYY, where |
| | | | P = 1-5, HH = 01-18, YYY = 001-999) |
| CT4PHY14 | NUM | 6 | Par, handicap, and yardage for this tee (e.g., PHHYYY, where |
| | | | P = 1-5, HH = 01-18, YYY = 001-999) |
| CT4PHY15 | NUM | 6 | Par, handicap, and yardage for this tee (e.g., PHHYYY, where |
| | | | P = 1-5, HH = 01-18, YYY = 001-999) |
| CT4PHY16 | NUM | 6 | Par, handicap, and yardage for this tee (e.g., PHHYYY, where |
| | | | P = 1-5, HH = 01-18, YYY = 001-999) |
| CT4PHY17 | NUM | 6 | Par, handicap, and yardage for this tee (e.g., PHHYYY, where |
| | | | P = 1-5, HH = 01-18, YYY = 001-999) |
| CT4PHY18 | NUM | 6 | Par, handicap, and yardage for this tee (e.g., PHHYYY, where |
| | | | P = 1-5, HH = 01-18, YYY = 001-999) |
| CT5PHY1 | NUM | 6 | Par, handicap, and yardage for this tee (e.g., PHHYYY, where |
| | | | P = 1-5, HH = 01-18, YYY = 001-999) |
| CT5PHY2 | NUM | 6 | Par, handicap, and yardage for this tee (e.g., PHHYYY, where |
| | | | P = 1-5, HH = 01-18, YYY = 001-999) |
| CT5PHY3 | NUM | 6 | Par, handicap, and yardage for this tee (e.g., PHHYYY, where |
| | | | P = 1-5, HH = 01-18, YYY = 001-999) |
| CT5PHY4 | NUM | 6 | Par, handicap, and yardage for this tee (e.g., PHHYYY, where |
| | | | P = 1-5, HH = 01-18, YYY = 001-999) |
| CT5PHY5 | NUM | 6 | Par, handicap, and yardage for this tee (e.g., PHHYYY, where |
| | | | P = 1-5, HH = 01-18, YYY = 001-999) |
| CT5PHY6 | NUM | 6 | Par, handicap, and yardage for this tee (e.g., PHHYYY, where |
| | | | P = 1-5, HH = 01-18, YYY = 001-999) |
| CT5PHY7 | NUM | 6 | Par, handicap, and yardage for this tee (e.g., PHHYYY, where |
| | | | P = 1-5, HH = 01-18, YYY = 001-999) |
| CT5PHY8 | NUM | 6 | Par, handicap, and yardage for this tee (e.g., PHHYYY, where |
| | | | P = 1-5, HH = 01-18, YYY = 001-999) |
| CT5PHY9 | NUM | 6 | Par, handicap, and yardage for this tee (e.g., PHHYYY, where |
| | | | P = 1-5, HH = 01-18, YYY = 001-999) |
| CT5PHY10 | NUM | 6 | Par, handicap, and yardage for this tee (e.g., PHHYYY, where |
| | | | P = 1-5, HH = 01-18, YYY = 001-999) |
| CT5PHY11 | NUM | 6 | Par, handicap, and yardage for this tee (e.g., PHHYYY, where |
| | | | P = 1-5, HH = 01-18, YYY = 001-999) |
| CT5PHY12 | NUM | 6 | Par, handicap, and yardage for this tee (e.g., PHHYYY, where |
| | | | P = 1-5, HH = 01-18, YYY = 001-999) |
| CT5PHY13 | NUM | 6 | Par, handicap, and yardage for this tee (e.g., PHHYYY, where |
| | | | P = 1-5, HH = 01-18, YYY = 001-999) |
| CT5PHY14 | NUM | 6 | Par, handicap, and yardage for this tee (e.g., PHHYYY, where |
| | | | P = 1-5, HH = 01-18, YYY = 001-999) |
| CT5PHY15 | NUM | 6 | Par, handicap, and yardage for this tee (e.g., PHHYYY, where |
| | | | P = 1-5, HH = 01-18, YYY = 001-999) |
| CT5PHY16 | NUM | 6 | Par, handicap, and yardage for this tee (e.g., PHHYYY, where |
| | | | P = 1-5, HH = 01-18, YYY = 001-999) |
| CT5PHY17 | NUM | 6 | Par, handicap, and yardage for this tee (e.g., PHHYYY, where |
| | | | P = 1-5, HH = 01-18, YYY = 001-999) |
| CT5PHY18 | NUM | 6 | Par, handicap, and yardage for this tee (e.g., PHHYYY, where |
| | | | P = 1-5, HH = 01-18, YYY = 001-999) |
| CT6PHY1 | NUM | 6 | Par, handicap, and yardage for this tee (e.g., PHHYYY, where |
| | | | P = 1-5, HH = 01-18, YYY = 001-999) |
| CT6PHY2 | NUM | 6 | Par, handicap, and yardage for this tee (e.g., PHHYYY, where |
| | | | P = 1-5, HH = 01-18, YYY = 001-999) |
| CT6PHY3 | NUM | 6 | Par, handicap, and yardage for this tee (e.g., PHHYYY, where |
| | | | P = 1-5, HH = 01-18, YYY = 001-999) |
| CT6PHY4 | NUM | 6 | Par, handicap, and yardage for this tee (e.g., PHHYYY, where |
| | | | P = 1-5, HH = 01-18, YYY = 001-999) |
| CT6PHY5 | NUM | 6 | Par, handicap, and yardage for this tee (e.g., PHHYYY, where |
| | | | P = 1-5, HH = 01-18, YYY = 001-999) |
| CT6PHY6 | NUM | 6 | Par, handicap, and yardage for this tee (e.g., PHHYYY, where |
| | | | P = 1-5, HH = 01-18, YYY = 001-999) |
| CT6PHY7 | NUM | 6 | Par, handicap, and yardage for this tee (e.g., PHHYYY, where |
| | | | P = 1-5, HH = 01-18, YYY = 001-999) |
| CT6PHY8 | NUM | 6 | Par, handicap, and yardage for this tee (e.g., PHHYYY, where |
| | | | P = 1-5, HH = 01-18, YYY = 001-999) |
| CT6PHY9 | NUM | 6 | Par, handicap, and yardage for this tee (e.g., PHHYYY, where |
| | | | P = 1-5, HH = 01-18, YYY = 001-999) |
| CT6PHY10 | NUM | 6 | Par, handicap, and yardage for this tee (e.g., PHHYYY, where |
| | | | P = 1-5, HH = 01-18, YYY = 001-999) |
| CT6PHY11 | NUM | 6 | Par, handicap, and yardage for this tee (e.g., PHHYYY, where |
| | | | P = 1-5, HH = 01-18, YYY = 001-999) |
| CT6PHY12 | NUM | 6 | Par, handicap, and yardage for this tee (e.g., PHHYYY, where |
| | | | P = 1-5, HH = 01-18, YYY = 001-999) |
| CT6PHY13 | NUM | 6 | Par, handicap, and yardage for this tee (e.g., PHHYYY, where |
| | | | P = 1-5, HH = 01-18, YYY = 001-999) |
| CT6PHY14 | NUM | 6 | Par, handicap, and yardage for this tee (e.g., PHHYYY, where |
| | | | P = 1-5, HH = 01-18, YYY = 001-999) |
| CT6PHY15 | NUM | 6 | Par, handicap, and yardage for this tee (e.g., PHHYYY, where |
| | | | P = 1-5, HH = 01-18, YYY = 001-999) |
| CT6PHY16 | NUM | 6 | Par, handicap, and yardage for this tee (e.g., PHHYYY, where |
| | | | P = 1-5, HH = 01-18, YYY = 001-999) |
| CT6PHY17 | NUM | 6 | Par, handicap, and yardage for this tee (e.g., PHHYYY, where |
| | | | P = 1-5, HH = 01-18, YYY = 001-999) |
| CT6PHY18 | NUM | 6 | Par, handicap, and yardage for this tee (e.g., PHHYYY, where |
| | | | P = 1-5, HH = 01-18, YYY = 001-999) |
| CGPSGRNC1 | GPS | | GPS coordinates for center of the green for hole 1 |
| CGPSGRNC2 | GPS | | GPS coordinates for center of the green for hole 2 |
| CGPSGRNC3 | GPS | | GPS coordinates for center of the green for hole 3 |
| CGPSGRNC4 | GPS | | GPS coordinates for center of the green for hole 4 |
| CGPSGRNC5 | GPS | | GPS coordinates for center of the green for hole 5 |
| CGPSGRNC6 | GPS | | GPS coordinates for center of the green for hole 6 |
| CGPSGRNC7 | GPS | | GPS coordinates for center of the green for hole 7 |
| CGPSGRNC8 | GPS | | GPS coordinates for center of the green for hole 8 |
| CGPSGRNC9 | GPS | | GPS coordinates for center of the green for hole 9 |
| CGPSGRNC10 | GPS | | GPS coordinates for center of the green for hole 10 |
| CGPSGRNC11 | GPS | | GPS coordinates for center of the green for hole 11 |
| CGPSGRNC12 | GPS | | GPS coordinates for center of the green for hole 12 |
| CGPSGRNC13 | GPS | | GPS coordinates for center of the green for hole 13 |
| CGPSGRNC14 | GPS | | GPS coordinates for center of the green for hole 14 |
| CGPSGRNC15 | GPS | | GPS coordinates for center of the green for hole 15 |
| CGPSGRNC16 | GPS | | GPS coordinates for center of the green for hole 16 |
| CGPSGRNC17 | GPS | | GPS coordinates for center of the green for hole 17 |
| CGPSGRNC18 | GPS | | GPS coordinates for center of the green for hole 18 |
| GPSGRNL1 | GPS | | GPS coordinates for left edge of the green for hole 1 |
| GPSGRNL2 | GPS | | GPS coordinates for left edge of the green for hole 2 |
| GPSGRNL3 | GPS | | GPS coordinates for left edge of the green for hole 3 |
| GPSGRNL4 | GPS | | GPS coordinates for left edge of the green for hole 4 |
| GPSGRNL5 | GPS | | GPS coordinates for left edge of the green for hole 5 |
| GPSGRNL6 | GPS | | GPS coordinates for left edge of the green for hole 6 |
| GPSGRNL7 | GPS | | GPS coordinates for left edge of the green for hole 7 |
| GPSGRNL8 | GPS | | GPS coordinates for left edge of the green for hole 8 |
| GPSGRNL9 | GPS | | GPS coordinates for left edge of the green for hole 9 |
| GPSGRNL10 | GPS | | GPS coordinates for left edge of the green for hole 10 |
| GPSGRNL11 | GPS | | GPS coordinates for left edge of the green for hole 11 |
| GPSGRNL12 | GPS | | GPS coordinates for left edge of the green for hole 12 |
| GPSGRNL13 | GPS | | GPS coordinates for left edge of the green for hole 13 |
| GPSGRNL14 | GPS | | GPS coordinates for left edge of the green for hole 14 |
| GPSGRNL15 | GPS | | GPS coordinates for left edge of the green for hole 15 |
| GPSGRNL16 | GPS | | GPS coordinates for left edge of the green for hole 16 |
| GPSGRNL17 | GPS | | GPS coordinates for left edge of the green for hole 17 |
| GPSGRNL18 | GPS | | GPS coordinates for left edge of the green for hole 18 |
| GPSGRNR1 | GPS | | GPS coordinates for right edge of the green for hole 1 |
| GPSGRNR2 | GPS | | GPS coordinates for right edge of the green for hole 2 |
| GPSGRNR3 | GPS | | GPS coordinates for right edge of the green for hole 3 |
| GPSGRNR4 | GPS | | GPS coordinates for right edge of the green for hole 4 |
| GPSGRNR5 | GPS | | GPS coordinates for right edge of the green for hole 5 |
| GPSGRNR6 | GPS | | GPS coordinates for right edge of the green for hole 6 |
| GPSGRNR7 | GPS | | GPS coordinates for right edge of the green for hole 7 |
| GPSGRNR8 | GPS | | GPS coordinates for right edge of the green for hole 8 |
| GPSGRNR9 | GPS | | GPS coordinates for right edge of the green for hole 9 |
| GPSGRNR10 | GPS | | GPS coordinates for right edge of the green for hole 10 |
| GPSGRNR11 | GPS | | GPS coordinates for right edge of the green for hole 11 |
| GPSGRNR12 | GPS | | GPS coordinates for right edge of the green for hole 12 |
| GPSGRNR13 | GPS | | GPS coordinates for right edge of the green for hole 13 |
| GPSGRNR14 | GPS | | GPS coordinates for right edge of the green for hole 14 |
| GPSGRNR15 | GPS | | GPS coordinates for right edge of the green for hole 15 |
| GPSGRNR16 | GPS | | GPS coordinates for right edge of the green for hole 16 |
| GPSGRNR17 | GPS | | GPS coordinates for right edge of the green for hole 17 |
| GPSGRNR18 | GPS | | GPS coordinates for right edge of the green for hole 18 |
| GPSGRNB1 | GPS | | GPS coordinates for back edge of the green for hole 1 |
| GPSGRNB2 | GPS | | GPS coordinates for back edge of the green for hole 2 |
| GPSGRNB3 | GPS | | GPS coordinates for back edge of the green for hole 3 |
| GPSGRNB4 | GPS | | GPS coordinates for back edge of the green for hole 4 |
| GPSGRNB5 | GPS | | GPS coordinates for back edge of the green for hole 5 |
| GPSGRNB6 | GPS | | GPS coordinates for back edge of the green for hole 6 |
| GPSGRNB7 | GPS | | GPS coordinates for back edge of the green for hole 7 |
| GPSGRNB8 | GPS | | GPS coordinates for back edge of the green for hole 8 |
| GPSGRNB9 | GPS | | GPS coordinates for back edge of the green for hole 9 |
| GPSGRNB10 | GPS | | GPS coordinates for back edge of the green for hole 10 |
| GPSGRNB11 | GPS | | GPS coordinates for back edge of the green for hole 11 |
| GPSGRNB12 | GPS | | GPS coordinates for back edge of the green for hole 12 |
| GPSGRNB13 | GPS | | GPS coordinates for back edge of the green for hole 13 |
| GPSGRNB14 | GPS | | GPS coordinates for back edge of the green for hole 14 |
| GPSGRNB15 | GPS | | GPS coordinates for back edge of the green for hole 15 |
| GPSGRNB16 | GPS | | GPS coordinates for back edge of the green for hole 16 |
| GPSGRNB17 | GPS | | GPS coordinates for back edge of the green for hole 17 |
| GPSGRNB18 | GPS | | GPS coordinates for back edge of the green for hole 18 |
| GPSMRK11 | | | The database should be able to hold GPS |
| GPSMRK21 | | | coordinates for up to 10 different markers for each |
| GPSMRK31 | | | hole on a course. Each marker must be identified |
| GPSMRK41 | | | by type (trap, water, tree, other), and must allow |
| GPSMRK51 | | | for right, left, back, front, and center of the |
| GPSMRK61 | | {close oversize brace} | marker. This must be dynamic, as the user may |
| GPSMRK71 | | | identify one marker on one hole, three on another |
| GPSMRK81 | | | none on another, six on another, etc. In addition, |
| GPSMRK91 | | | courses stored on our web site may have up to 10 |
| GPSMRK101 | | | markers as well, and must be downloadable to the |
| | | | field unit. |

TABLE 5
Rounds Database Description

| | Data | | |
|---|---|---|---|
| Data Name | Type | Length | Description |
| RPNUMB | NUM | 4 | Unique player number for this round |
| RCNUMB | NUM | 4 | Unique course number for this round |
| RCDATE | DATE | 8 | Date round is played, e.g., 09032001 |
| RPSCOREG | NUM | 3 | Player's total score (gross) |
| RPSCOREN | NUM | 3 | Player's total score (net) - calculated as RPSCOREG minus |
| | | | handicap as of date of the round |
| RTHOLE1 | NUM | 2 | Total score for this hole |
| RTHOLE2 | NUM | 2 | Total score for this hole |
| RTHOLE3 | NUM | 2 | Total score for this hole |
| RTHOLE4 | NUM | 2 | Total score for this hole |
| RTHOLE5 | NUM | 2 | Total score for this hole |
| RTHOLE6 | NUM | 2 | Total score for this hole |
| RTHOLE7 | NUM | 2 | Total score for this hole |
| RTHOLE8 | NUM | 2 | Total score for this hole |
| RTHOLE9 | NUM | 2 | Total score for this hole |
| RTHOLE10 | NUM | 2 | Total score for this hole |
| RTHOLE11 | NUM | 2 | Total score for this hole |
| RTHOLE12 | NUM | 2 | Total score for this hole |
| RTHOLE13 | NUM | 2 | Total score for this hole |
| RTHOLE14 | NUM | 2 | Total score for this hole |
| RTHOLE15 | NUM | 2 | Total score for this hole |
| RTHOLE16 | NUM | 2 | Total score for this hole |
| RTHOLE17 | NUM | 2 | Total score for this hole |
| RTHOLE18 | NUM | 2 | Total score for this hole |
| RPHOLE1 | NUM | 2 | Total putts for this hole |
| RPHOLE2 | NUM | 2 | Total putts for this hole |
| RPHOLE3 | NUM | 2 | Total putts for this hole |
| RPHOLE4 | NUM | 2 | Total putts for this hole |
| RPHOLE5 | NUM | 2 | Total putts for this hole |
| RPHOLE6 | NUM | 2 | Total putts for this hole |
| RPHOLE7 | NUM | 2 | Total putts for this hole |
| RPHOLE8 | NUM | 2 | Total putts for this hole |
| RPHOLE9 | NUM | 2 | Total putts for this hole |
| RPHOLE10 | NUM | 2 | Total putts for this hole |
| RPHOLE11 | NUM | 2 | Total putts for this hole |
| RPHOLE12 | NUM | 2 | Total putts for this hole |
| RPHOLE13 | NUM | 2 | Total putts for this hole |
| RPHOLE14 | NUM | 2 | Total putts for this hole |
| RPHOLE15 | NUM | 2 | Total putts for this hole |
| RPHOLE16 | NUM | 2 | Total putts for this hole |
| RPHOLE17 | NUM | 2 | Total putts for this hole |
| RPHOLE18 | NUM | 2 | Total putts for this hole |
| RFHOLE1 | CHAR | 1 | If drive in fairway, then C; if left, then L; if right, then R |
| RFHOLE2 | CHAR | 1 | If drive in fairway, then C; if left, then L; if right, then R |
| RFHOLE3 | CHAR | 1 | If drive in fairway, then C; if left, then L; if right, then R |
| RFHOLE4 | CHAR | 1 | If drive in fairway, then C; if left, then L; if right, then R |
| RFHOLE5 | CHAR | 1 | If drive in fairway, then C; if left, then L; if right, then R |
| RFHOLE6 | CHAR | 1 | If drive in fairway, then C; if left, then L; if right, then R |
| RFHOLE7 | CHAR | 1 | If drive in fairway, then C; if left, then L; if right, then R |
| RFHOLE8 | CHAR | 1 | If drive in fairway, then C; if left, then L; if right, then R |
| RFHOLE9 | CHAR | 1 | If drive in fairway, then C; if left, then L; if right, then R |
| RFHOLE10 | CHAR | 1 | If drive in fairway, then C; if left, then L; if right, then R |
| RFHOLE11 | CHAR | 1 | If drive in fairway, then C; if left, then L; if right, then R |
| RFHOLE12 | CHAR | 1 | If drive in fairway, then C; if left, then L; if right, then R |
| RFHOLE13 | CHAR | 1 | If drive in fairway, then C; if left, then L; if right, then R |
| RFHOLE14 | CHAR | 1 | If drive in fairway, then C; if left, then L; if right, then R |
| RFHOLE15 | CHAR | 1 | If drive in fairway, then C; if left, then L; if right, then R |
| RFHOLE16 | CHAR | 1 | If drive in fairway, then C; if left, then L; if right, then R |
| RFHOLE17 | CHAR | 1 | If drive in fairway, then C; if left, then L; if right, then R |
| RFHOLE18 | CHAR | 1 | If drive in fairway, then C; if left, then L; if right, then R |
| RGHOLE1 | CHAR | 1 | If hit green in regulation, then Y; else N |
| RGHOLE2 | CHAR | 1 | If hit green in regulation, then Y; else N |
| RGHOLE3 | CHAR | 1 | If hit green in regulation, then Y; else N |
| RGHOLE4 | CHAR | 1 | If hit green in regulation, then Y; else N |
| RGHOLE5 | CHAR | 1 | If hit green in regulation, then Y; else N |
| RGHOLE6 | CHAR | 1 | If hit green in regulation, then Y; else N |
| RGHOLE7 | CHAR | 1 | If hit green in regulation, then Y; else N |
| RGHOLE8 | CHAR | 1 | If hit green in regulation, then Y; else N |
| RGHOLE9 | CHAR | 1 | If hit green in regulation, then Y; else N |
| RGHOLE10 | CHAR | 1 | If hit green in regulation, then Y; else N |
| RGHOLE11 | CHAR | 1 | If hit green in regulation, then Y; else N |
| RGHOLE12 | CHAR | 1 | If hit green in regulation, then Y; else N |
| RGHOLE13 | CHAR | 1 | If hit green in regulation, then Y; else N |
| RGHOLE14 | CHAR | 1 | If hit green in regulation, then Y; else N |
| RGHOLE15 | CHAR | 1 | If hit green in regulation, then Y; else N |
| RGHOLE16 | CHAR | 1 | If hit green in regulation, then Y; else N |
| RGHOLE17 | CHAR | 1 | If hit green in regulation, then Y; else N |
| RGHOLE18 | CHAR | 1 | If hit green in regulation, then Y; else N |
| RSHOLE1 | CHAR | 2 | PR = par; BR = birdie; EG = eagle; BG = bogey; DB = double |
| | | | bogey; TB = triple bogey |
| RSHOLE2 | CHAR | 2 | PR = par; BR = birdie; EG = eagle; BG = bogey; DB = double |
| | | | bogey; TB = triple bogey |
| RSHOLE3 | CHAR | 2 | PR = par; BR = birdie; EG = eagle; BG = bogey; DB = double |
| | | | bogey; TB = triple bogey |
| RSHOLE4 | CHAR | 2 | PR = par; BR = birdie; EG = eagle; BG = bogey; DB = double |
| | | | bogey; TB = triple bogey |
| RSHOLE5 | CHAR | 2 | PR = par; BR = birdie; EG = eagle; BG = bogey; DB = double |
| | | | bogey; TB = triple bogey |
| RSHOLE6 | CHAR | 2 | PR = par; BR = birdie; EG = eagle; BG = bogey; DB = double |
| | | | bogey; TB = triple bogey |
| RSHOLE7 | CHAR | 2 | PR = par; BR = birdie; EG = eagle; BG = bogey; DB = double |
| | | | bogey; TB = triple bogey |
| RSHOLE8 | CHAR | 2 | PR = par; BR = birdie; EG = eagle; BG = bogey; DB = double |
| | | | bogey; TB = triple bogey |
| RSHOLE9 | CHAR | 2 | PR = par; BR = birdie; EG = eagle; BG = bogey; DB = double |
| | | | bogey; TB = triple bogey |
| RSHOLE10 | CHAR | 2 | PR = par; BR = birdie; EG = eagle; BG = bogey; DB = double |
| | | | bogey; TB = triple bogey |
| RSHOLE11 | CHAR | 2 | PR = par; BR = birdie; EG = eagle; BG = bogey; DB = double |
| | | | bogey; TB = triple bogey |
| RSHOLE12 | CHAR | 2 | PR = par; BR = birdie; EG = eagle; BG = bogey; DB = double |
| | | | bogey; TB = triple bogey |
| RSHOLE13 | CHAR | 2 | PR = par; BR = birdie; EG = eagle; BG = bogey; DB = double |
| | | | bogey; TB = triple bogey |
| RSHOLE14 | CHAR | 2 | PR = par; BR = birdie; EG = eagle; BG = bogey; DB = double |
| | | | bogey; TB = triple bogey |
| RSHOLE15 | CHAR | 2 | PR = par; BR = birdie; EG = eagle; BG = bogey; DB = double |
| | | | bogey; TB = triple bogey |
| RSHOLE16 | CHAR | 2 | PR = par; BR = birdie; EG = eagle; BG = bogey; DB = double |
| | | | bogey; TB = triple bogey |
| RSHOLE17 | CHAR | 2 | PR = par; BR = birdie; EG = eagle; BG = bogey; DB = double |
| | | | bogey; TB = triple bogey |
| RSHOLE18 | CHAR | 2 | PR = par; BR = birdie; EG = eagle; BG = bogey; DB = double |
| | | | bogey; TB = triple bogey |
| RPSHOLE1 | NUM | 2 | Number penalty strokes this hole |
| RPSHOLE2 | NUM | 2 | Number penalty strokes this hole |
| RPSHOLE3 | NUM | 2 | Number penalty strokes this hole |
| RPSHOLE4 | NUM | 2 | Number penalty strokes this hole |
| RPSHOLE5 | NUM | 2 | Number penalty strokes this hole |
| RPSHOLE6 | NUM | 2 | Number penalty strokes this hole |
| RPSHOLE7 | NUM | 2 | Number penalty strokes this hole |
| RFSHOLE8 | NUM | 2 | Number penalty strokes this hole |
| RPSHOLE9 | NUM | 2 | Number penalty strokes this hole |
| RPSHOLE10 | NUM | 2 | Number penalty strokes this hole |
| RPSHOLE11 | NUM | 2 | Number penalty strokes this hole |
| RPSHOLE12 | NUM | 2 | Number penalty strokes this hole |
| RPSHOLE13 | NUM | 2 | Number penalty strokes this hole |
| RPSHOLE14 | NUM | 2 | Number penalty strokes this hole |
| RPSHOLE15 | NUM | 2 | Number penalty strokes this hole |
| RPSHOLE16 | NUM | 2 | Number penalty strokes this hole |
| RPSHOLE17 | NUM | 2 | Number penalty strokes this hole |
| RPSHOLE18 | NUM | 2 | Number penalty strokes this hole |
| RS1HOLE1 | NUM | 5 | Club and distance for shot 1, hole 1. First two digits is |
| | | | PCLUB# (01-16), last three digits is yardage |
| RS2HOLE1 | NUM | 5 | Same for shot 2 |
| RS3HOLE1 | NUM | 5 | Same for shot 3 |
| RS4HOLE1 | NUM | 5 | Same for shot 4 |
| RS5HOLE1 | NUM | 5 | Same for shot 5 |
| RS6HOLE1 | NUM | 5 | Same for shot 6 |
| RS7HOLE1 | NUM | 5 | Same for shot 7 |
| RS8HOLE1 | NUM | 5 | Same for shot 8 |
| RS9HOLE1 | NUM | 5 | Same for shot 9 |
| RS10HOLE1 | NUM | 5 | Same for shot 10 |
| RS1HOLE2 | NUM | 5 | Club and distance for shot 1, hole 2. First two digits is |
| | | | PCLUB# (01-16), last three digits is yardage |
| RS2HOLE2 | NUM | 5 | Same for shot 2 |
| RS3HOLE2 | NUM | 5 | Same for shot 3 |
| RS4HOLE2 | NUM | 5 | Same for shot 4 |
| RS5HOLE2 | NUM | 5 | Same for shot 5 |
| RS6HOLE2 | NUM | 5 | Same for shot 6 |
| RS7HOLE2 | NUM | 5 | Same for shot 7 |
| RS8HOLE2 | NUM | 5 | Same for shot 8 |
| RS9HOLE2 | NUM | 5 | Same for shot 9 |
| RS10HOLE2 | NUM | 5 | Same for shot 10 |
| RS1HOLE3 | NUM | 5 | Club and distance for shot 1, hole 3. First two digits is |
| | | | PCLUB# (01-16), last three digits is yardage |
| RS2HOLE3 | NUM | 5 | Same for shot 2 |
| RS3HOLE3 | NUM | 5 | Same for shot 3 |
| RS4HOLE3 | NUM | 5 | Same for shot 4 |
| RS5HOLE3 | NUM | 5 | Same for shot 5 |
| RS6HOLE3 | NUM | 5 | Same for shot 6 |
| RS7HOLE3 | NUM | 5 | Same for shot 7 |
| RS8HOLE3 | NUM | 5 | Same for shot 8 |
| RS9HOLE3 | NUM | 5 | Same for shot 9 |
| RS10HOLE3 | NUM | 5 | Same for shot 10 |
| RS1HOLE4 | NUM | 5 | Club and distance for shot 1, hole 4. First two digits is |
| | | | PCLUB# (01-16), last three digits is yardage |
| RS2HOLE4 | NUM | 5 | Same for shot 2 |
| RS3HOLE4 | NUM | 5 | Same for shot 3 |
| RS4HOLE4 | NUM | 5 | Same for shot 4 |
| RS5HOLE4 | NUM | 5 | Same for shot 5 |
| RS6HOLE4 | NUM | 5 | Same for shot 6 |
| RS7HOLE4 | NUM | 5 | Same for shot 7 |
| RS8HOLE4 | NUM | 5 | Same for shot 8 |
| RS9HOLE4 | NUM | 5 | Same for shot 9 |
| RS10HOLE4 | NUM | 5 | Same for shot 10 |
| RS1HOLE5 | NUM | 5 | Club and distance for shot 1, hole 5. First two digits is |
| | | | PCLUB# (01-16), last three digits is yardage |
| RS2HOLE5 | NUM | 5 | Same for shot 2 |
| RS3HOLE5 | NUM | S | Same for shot 3 |
| RS4HOLE5 | NUM | S | Same for shot 4 |
| RS5HOLE5 | NUM | 5 | Same for shot 5 |
| RS6HOLE5 | NUM | 5 | Same for shot 6 |
| RS7HOLE5 | NUM | 5 | Same for shot 7 |
| RS8HOLE5 | NUM | 5 | Same for shot 8 |
| RS9HOLE5 | NUM | 5 | Same for shot 9 |
| RS10HOLE5 | NUM | 5 | Same for shot 10 |
| RS1HOLE6 | NUM | 5 | Club and distance for shot 1, hole 6. First two digits is |
| | | | PCLUB# (01-16), last three digits is yardage |
| RS2HOLE6 | NUM | 5 | Same for shot 2 |
| RS3HOLE6 | NUM | 5 | Same for shot 3 |
| RS4HOLE6 | NUM | 5 | Same for shot 4 |
| RS5HOLE6 | NUM | 5 | Same for shot 5 |
| RS6HOLE6 | NUM | 5 | Same for shot 6 |
| RS7HOLE6 | NUM | 5 | Same for shot 7 |
| RS8HOLE6 | NUM | 5 | Same for shot 8 |
| RS9HOLE6 | NUM | 5 | Same for shot 9 |
| RS10HOLE6 | NUM | 5 | Same for shot 10 |
| RS1HOLE7 | NUM | 5 | Club and distance for shot 1, hole 7. First two digits is |
| | | | PCLUB# (01-16), last three digits is yardage |
| RS2HOLE7 | NUM | 5 | Same for shot 2 |
| RS3HOLE7 | NUM | 5 | Same for shot 3 |
| RS4HOLE7 | NUM | 5 | Same for shot 4 |
| RS5HOLE7 | NUM | 5 | Same for shot 5 |
| RS6HOLE7 | NUM | 5 | Same for shot 6 |
| RS7HOLE7 | NUM | S | Same for shot 7 |
| RS8HOLE7 | NUM | 5 | Same for shot 8 |
| RS9HOLE7 | NUM | 5 | Same for shot 9 |
| RS10HOLE7 | NUM | 5 | Same for shot 10 |
| RS1HOLE8 | NUM | 5 | Club and distance for shot 1, hole 8. First two digits is |
| | | | PCLUB# (01-16), last three digits is yardage |
| RS2HOLE8 | NUM | 5 | Same for shot 2 |
| RS3HOLE8 | NUM | 5 | Same for shot 3 |
| RS4HOLE8 | NUM | 5 | Same for shot 4 |
| RS5HOLE8 | NUM | 5 | Same for shot 5 |
| RS6HOLE8 | NUM | 5 | Same for shot 6 |
| RS7HOLE8 | NUM | 5 | Same for shot 7 |
| RS8HOLE8 | NUM | 5 | Same for shot 8 |
| RS9HOLE8 | NUM | 5 | Same for shot 9 |
| RS10HOLE8 | NUM | 5 | Same for shot 10 |
| RS1HOLE9 | NUM | 5 | Club and distance for shot 1, hole 9. First two digits is |
| | | | PCLUB# (01-16), last three digits is yardage |
| RS2HOLE9 | NUM | 5 | Same for shot 2 |
| RS3HOLE9 | NUM | 5 | Same for shot 3 |
| RS4HOLE9 | NUM | 5 | Same for shot 4 |
| RS5HOLE9 | NUM | 5 | Same for shot 5 |
| RS6HOLE9 | NUM | 5 | Same for shot 6 |
| RS7HOLE9 | NUM | 5 | Same for shot 7 |
| RS8HOLE9 | NUM | 5 | Same for shot 8 |
| RS9HOLE9 | NUM | 5 | Same for shot 9 |
| RS10HOLE9 | NUM | 5 | Same for shot 10 |
| RS1HOLE10 | NUM | 5 | Club and distance for shot 1, hole 10. First two digits is |
| | | | PCLUB# (01-16), last three digits is yardage |
| RS2HOLE10 | NUM | 5 | Same for shot 2 |
| RS3HOLE10 | NUM | 5 | Same for shot 3 |
| RS4HOLE10 | NUM | 5 | Same for shot 4 |
| RS5HOLE10 | NUM | 5 | Same for shot 5 |
| RS6HOLE10 | NUM | 5 | Same for shot 6 |
| RS7HOLE10 | NUM | 5 | Same for shot 7 |
| RS8HOLE10 | NUM | 5 | Same for shot 8 |
| RS9HOLE10 | NUM | 5 | Same for shot 9 |
| RS10HOLE10 | NUM | 5 | Same for shot 10 |
| RS1HOLE11 | NUM | 5 | Club and distance for shot 1, hole 11. First two digits is |
| | | | PCLUB# (01-16), last three digits is yardage |
| RS2HOLE11 | NUM | 5 | Same for shot 2 |
| RS3HOLE11 | NUM | 5 | Same for shot 3 |
| RS4HOLE11 | NUM | 5 | Same for shot 4 |
| RS5HOLE11 | NUM | 5 | Same for shot 5 |
| RS6HOLE11 | NUM | 5 | Same for shot 6 |
| RS7HOLE11 | NUM | 5 | Same for shot 7 |
| RS8HOLE11 | NUM | 5 | Same for shot 8 |
| RS9HOLE11 | NUM | 5 | Same for shot 9 |
| RS10HOLE11 | NUM | 5 | Same for shot 10 |
| RS1HOLE12 | NUM | 5 | Club and distance for shot 1, hole 12. First two digits is |
| | | | PCLUB# (01-16), last three digits is yardage |
| RS2HOLE12 | NUM | 5 | Same for shot 2 |
| RS3HOLE12 | NUM | 5 | Same for shot 3 |
| RS4HOLE12 | NUM | 5 | Same for shot 4 |
| RS5HOLE12 | NUM | 5 | Same for shot 5 |
| RS6HOLE12 | NUM | 5 | Same for shot 6 |
| RS7HOLE12 | NUM | 5 | Same for shot 7 |
| RS8HOLE12 | NUM | 5 | Same for shot 8 |
| RS9HOLE12 | NUM | 5 | Same for shot 9 |
| RS10HOLE12 | NUM | 5 | Same for shot 10 |
| RS1HOLE13 | NUM | 5 | Club and distance for shot 1, hole 13. First two digits is |
| | | | PCLUB# (01-16), last three digits is yardage |
| RS2HOLE13 | NUM | 5 | Same for shot 2 |
| RS3HOLE13 | NUM | 5 | Same for shot 3 |
| RS4HOLE13 | NUM | 5 | Same for shot 4 |
| RS5HOLE13 | NUM | 5 | Same for shot 5 |
| RS6HOLE13 | NUM | 5 | Same for shot 6 |
| RS7HOLE13 | NUM | 5 | Same for shot 7 |
| RS8HOLE13 | NUM | S | Same for shot 8 |
| RS9HOLE13 | NUM | 5 | Same for shot 9 |
| RS10HOLE13 | NUM | 5 | Same for shot 10 |
| RS1HOLE14 | NUM | 5 | Club and distance for shot 1, hole 14. First two digits is |
| | | | PCLUB# (01-16), last three digits is yardage |
| RS2HOLE14 | NUM | 5 | Same for shot 2 |
| RS3HOLE14 | NUM | 5 | Same for shot 3 |
| RS4HOLE14 | NUM | 5 | Same for shot 4 |
| RS5HOLE14 | NUM | 5 | Same for shot 5 |
| RS6HOLE14 | NUM | 5 | Same for shot 6 |
| RS7HOLE14 | NUM | 5 | Same for shot 7 |
| RS8HOLE14 | NUM | 5 | Same for shot 8 |
| RS9HOLE14 | NUM | 5 | Same for shot 9 |
| RS10HOLE14 | NUM | 5 | Same for shot 10 |
| RS1HOLE15 | NUM | 5 | Club and distance for shot 1, hole 15. First two digits is |
| | | | PCLUB# (01-16), last three digits is yardage |
| RS2HOLE15 | NUM | 5 | Same for shot 2 |
| RS3HOLE15 | NUM | 5 | Same for shot 3 |
| RS4HOLE15 | NUM | 5 | Same for shot 4 |
| RS5HOLE15 | NUM | 5 | Same for shot 5 |
| RS6HOLE15 | NUM | 5 | Same for shot 6 |
| RS7HOLE15 | NUM | 5 | Same for shot 7 |
| RS8HOLE15 | NUM | 5 | Same for shot 8 |
| RS9HOLE15 | NUM | 5 | Same for shot 9 |
| RS10HOLE15 | NUM | 5 | Same for shot 10 |
| RS1HOLE16 | NUM | 5 | Club and distance for shot 1, hole 16. First two digits is |
| | | | PCLUB# (01-16), last three digits is yardage |
| RS2HOLE16 | NUM | 5 | Same for shot 2 |
| RS3HOLE16 | NUM | 5 | Same for shot 3 |
| RS4HOLE16 | NUM | 5 | Same for shot 4 |
| RS5HOLE16 | NUM | 5 | Same for shot 5 |
| RS6HOLE16 | NUM | 5 | Same for shot 6 |
| RS7HOLE16 | NUM | 5 | Same for shot 7 |
| RS8HOLE16 | NUM | 5 | Same for shot 8 |
| RS9HOLE16 | NUM | 5 | Same for shot 9 |
| RS10HOLE16 | NUM | 5 | Same for shot 10 |
| RS1HOLE17 | NUM | 5 | Club and distance for shot 1, hole 17. First two digits is |
| | | | CLUB# (01-16), last three digits is yardage |
| RS2HOLE17 | NUM | 5 | Same for shot 2 |
| RS3HOLE17 | NUM | 5 | Same for shot 3 |
| RS4HOLE17 | NUM | 5 | Same for shot 4 |
| RS5HOLE17 | NUM | 5 | Same for shot 5 |
| RS6HOLE17 | NUM | 5 | Same for shot 6 |
| RS7HOLE17 | NUM | 5 | Same for shot 7 |
| RS8HOLE17 | NUM | 5 | Same for shot 8 |
| RS9HOLE17 | NUM | 5 | Same for shot 9 |
| RS10HOLE17 | NUM | 5 | Same for shot 10 |
| RS1HOLE18 | NUM | 5 | Club and distance for shot 1, hole 18. First two digits is |
| | | | PCLUB# (01-16), last three digits is yardage |
| RS2HOLE18 | NUM | 5 | Same for shot 2 |
| RS3HOLE18 | NUM | 5 | Same for shot 3 |
| RS4HOLE18 | NUM | 5 | Same for shot 4 |
| RS5HOLE18 | NUM | 5 | Same for shot 5 |
| RS6HOLE18 | NUM | 5 | Same for shot 6 |
| RS7HOLE18 | NUM | 5 | Same for shot 7 |
| RS8HOLE18 | NUM | 5 | Same for shot 8 |
| RS9HOLE18 | NUM | 5 | Same for shot 9 |
| RS10HOLE18 | NUM | 5 | Same for shot 10 |
| RMHOLE1 | NUM | 4 | Hole Matrix: 1st digit = save; 2nd digit = sand save; 3rd |
| | | | digit = up and down; 4th digit = chip in; default = 0 |
| RMHOLE2 | NUM | 4 | Hole Matrix: 1st digit = save; 2nd digit = sand save; 3rd |
| | | | digit = up and down; 4th digit = chip in; default = 0 |
| RMHOLE3 | NUM | 4 | Hole Matrix: 1st digit = save; 2nd digit = sand save; 3rd |
| | | | digit = up and down; 4th digit = chip in; default = 0 |
| RMHOLE4 | NUM | 4 | Hole Matrix: 1st digit = save; 2nd digit = sand save; 3rd |
| | | | digit = up and down; 4th digit = chip in; default = 0 |
| RMHOLE5 | NUM | 4 | Hole Matrix: 1st digit = save; 2nd digit = sand save; 3rd |
| | | | digit = up and down; 4th digit = chip in; default = 0 |
| RMHOLE6 | NUM | 4 | Hole Matrix: 1st digit = save; 2nd digit = sand save; 3rd |
| | | | digit = up and down; 4th digit = chip in; default = 0 |
| RMHOLE7 | NUM | 4 | Hole Matrix: 1st digit = save; 2nd digit = sand save; 3rd |
| | | | digit = up and down; 4th digit = chip in; default = 0 |
| RMHOLE8 | NUM | 4 | Hole Matrix: 1st digit = save; 2nd digit = sand save; 3rd |
| | | | digit = up and down; 4th digit = chip in; default = 0 |
| RMHOLE9 | NUM | 4 | Hole Matrix: 1st digit = save; 2nd digit = sand save; 3rd |
| | | | digit = up and down; 4th digit = chip in; default = 0 |
| RMHOLE10 | NUM | 4 | Hole Matrix: 1st digit = save; 2nd digit = sand save; 3rd |
| | | | digit = up and down; 4th digit = chip in; default = 0 |
| RMHOLE11 | NUM | 4 | Hole Matrix: 1st digit = save; 2nd digit = sand save; 3rd |
| | | | digit = up and down; 4th digit = chip in; default = 0 |
| RMHOLE12 | NUM | 4 | Hole Matrix: 1st digit = save; 2nd digit = sand save; 3rd |
| | | | digit = up and down; 4th digit = chip in; default = 0 |
| RMHOLE13 | NUM | 4 | Hole Matrix: 1st digit = save; 2nd digit = sand save; 3rd |
| | | | digit = up and down; 4th digit = chip in; default = 0 |
| RMHOLE14 | NUM | 4 | Hole Matrix: 1st digit = save; 2nd digit = sand save; 3rd |
| | | | digit = up and down; 4th digit = chip in; default = 0 |
| RMHOLE15 | NUM | 4 | Hole Matrix: 1st digit = save; 2nd digit = sand save; 3rd |
| | | | digit = up and down; 4th digit = chip in; default = 0 |
| RMHOLE16 | NUM | 4 | Hole Matrix: 1st digit = save; 2nd digit = sand save; 3rd |
| | | | digit = up and down; 4th digit = chip in; default = 0 |
| RMHOLE17 | NUM | 4 | Hole Matrix: 1st digit = save; 2nd digit = sand save; 3rd |
| | | | digit = up and down; 4th digit = chip in; default = 0 |
| RMHOLE18 | NUM | 4 | Hole Matrix: 1st digit = save; 2nd digit = sand save; 3rd |
| | | | digit = up and down; 4th digit = chip in; default = 0 |

In addition to the electronic assistant for golf, another application provides an electronic assistant for baseball, for providing electronic scorekeeping and statistics gathering. It is much more than merely another software tool. It is an extremely user friendly, comprehensive statistical collection and analytical tool designed to put decisional, situational awareness information at the fingertips of managers, coaches, scouts, players, scorekeepers, and fans at all levels of baseball and softball, and to provide a robust reporting capability to electronically submit statistical reporting information to league officials and news agencies. The key to the product is its ease of use, intuitive graphical user interface (i.e., the user does not need to know the mechanics of keeping baseball or softball scores), high reliability comprehensiveness, lightweight, weather-resistant and rugged construction, long battery life, and affordability. Several features make the baseball device a desirable tool for every competitive baseball and softball organization. These features include: the ability to store statistics for each game, team, and player, and to quickly and easily produce reports for electronic transmission to league officials and news agencies; the capability to provide immediate access to tendencies and probabilities on players and teams based on statistics and current game situations; the ability to collect scouting information on players and teams, including a radar gun interface for instantaneous collection of speed statistics and a digital recording capability to quickly and accurately collect voice notes on players and teams; and, immediate access via web interfaces to a variety of statistical databases at all levels of play (i.e., professional, college, high school, and youth) as well as software purchases, upgrades, and technical support.

More specifically, as applied to baseball, the electronic assistant could collect data to be used, for example, to recommend to the fielding team the most effective field positions or the best pitcher or type of pitch for a particular opposing batter or particular game situation. Similarly, it might recommend to the batting team which pinch hitter might be most effective, whether a right hand or left hand hitter is preferred, or what type of pitch to expect in a particular game situation.

The foregoing is considered as illustrative only of the principles of the invention. Further, since numerous modifications and changes will readily occur to those skilled in the art, it is not desired to limit the invention to the exact construction and operation shown and described, and accordingly all suitable modifications and equivalents may be regarded as falling within the scope of the invention.

I claim:

1. A portable, computerized personal electronic assistant for aiding a participant engaged in a preselected competitive event employing variably selectable event equipment, including at least a tangible projectile, and conducted in a defined event area, comprising:
a database storing historical data about marker positions in the defined event area, about a participant involved in the event, about variably selectable event equipment, and about prior results achieved with selected items of event equipment, and storing event conduct tips selected from the group consisting of event equipment selection tips, tactics tips, or combinations thereof;
a global positioning system device providing real time positional data to the database;
graphic display means for displaying a graphical representation of the defined event area in response to said historical and real time data in said database, said display including distancing information between a participant and said marker positions;
statistics collection means for collecting and recording in the database statistics relating to a participant's selection and use of variably selectable event equipment;
analysis means for providing real time event conduct tips derived from recorded statistics in the database and real time positional data

2. The personal electronic assistant of claim 1, further comprising:
a core module carrying a display screen with a touch screen graphical user interface enabling display of various graphical data according to programmed software, having engagement portions at each of two end walls, and having an internal expansion dock for receiving and communicating with a auxiliary device;
at least two expansion modules that are selectively attachable and removable from said engagement portions of said core module, wherein at least a first one of the expansion modules comprises a means for powering the core module.

3. The personal electronic assistant of claim 2, wherein a second one of said expansion modules comprises a module selected from the group consisting of a battery, a digital camera, a medical vital-signs module, a package scanner, a two-way radio, an automotive computer bus interface, or a combination thereof.

4. The personal electronic assistant of claim 2, wherein a second one of said expansion module comprises a second means for powering the core module, enabling continuous portable operation by alternating first and second expansion modules.

5. The personal electronic assistant of claim 2, wherein said global positioning system device comprises a module connected to said internal expansion dock.

6. The personal electronic assistant of claim 1, wherein:
the preselected competitive event is the game of golf;
the event area is a golf hole;
the variably selectable event equipment comprises a plurality of different golf clubs;
said positional data in the database is of pre-defined markers on a golf hole;
the real time distancing information provided by the global positioning system includes distance from a participant's location to a pre-defined marker;
further comprising:
programmed instructions providing a process according to the following scheme made available on said graphic display means:
initiating a new round of golf;
acquiring geographic data for the golf course hole;
maintaining a scorecard for round of golf;
recording available golf clubs for a player;
monitoring said player's performance with each club; and
recommending club selection for the player's current shot based upon said geographic data and the player's performance data with each club.

7. The personal electronic assistant of claim 6, wherein said programmed instructions to initiate a new round of golf comprise:
selecting initiation of new round;
selecting golf course for play of the new round;
selecting players for the new round;
selecting tees for each player in the round;
establishing a scorecard for the round;
recording a date for each hole as played; and
displaying the scorecard when the new round is complete.

8. The personal electronic assistant of claim 6, wherein said programmed instructions to input geographic data for the golf course hole comprise:
selecting entry of golf course data from the group consisting of a previously entered golf course or a non-previously entered golf course, and for a non-previously entered golf course, entering tee names, tee ratings, and tee slopes; and
selecting yardage options from the group consisting of recording GPS markers during play, entering hole yardage during play, and entering hole yardage before play.

9. The personal electronic assistant of claim 7, wherein said programmed instructions to select players for a new round of golf further comprise:
maintaining a historical identification of each of a plurality of players;
maintaining a historical handicap record for each of said plurality of players;
displaying an editable, default list of each of the plurality of player's golf clubs;
selecting a player from the plurality of players for edit of said historical record; and
entering said selected player on a scorecard record.

10. The personal electronic assistant of claim 1, wherein said analysis means further comprises:
a formulas database for calculating benchmarks from the content of said database.

11. The personal electronic assistant of claim 1, further comprising an audio output device operatively connected to said analysis means for aurally alerting a participant to the availability of a real time tip.

12. A portable, computerized personal electronic assistant for aiding a participant engaged in a preselected competitive event employing variably selectable event equipment, including at least a tangible projectile, and conducted in a defined event area, comprising:
a core module carrying a display screen with a touch screen graphical user interface enabling display of various graphical data according to programmed software, having engagement portions at each of two end walls, and having an internal expansion dock for receiving and communicating with a auxiliary device;
at least two expansion modules that are selectively attachable and removable from said engagement portions of said core module, wherein at least a first one of the expansion modules comprises a means for powering the core module.

13. The personal electronic assistant of claim 12, wherein a second one of said expansion modules comprises a module selected from the group consisting of a battery, a digital camera, a medical vital-signs module, a package scanner, a two-way radio, an automotive computer bus interface, or a combination thereof.

14. The personal electronic assistant of claim 12, wherein a second one of said expansion module comprises a second means for powering the core module, enabling continuous portable operation by alternating first and second expansion modules.

15. The personal electronic assistant of claim 12, further comprising:
a global positioning system module connected to said internal expansion dock.

16. The personal electronic assistant of claim 12, further comprising:
a database storing historical data about marker positions in the defined event area, about a participant involved in the event, about variably selectable event equipment, and about prior results achieved with selected items of event equipment, and storing event conduct tips selected from the group consisting of event equipment selection tips, tactics tips, or combinations thereof;
a global positioning system providing real time positional data to the database;
graphic display means for displaying a graphical representation of the defined event area in response to the historical and real time data in said database, said display including distancing information between a participant and said marker positions;
statistics collection means for collecting and recording in the database statistics relating to a participant's selection and use of variably selectable event equipment; and
analysis means for selecting and providing real time event conduct tips, selected by analysis of recorded statistics in the database and real time positional data.

17. The personal electronic assistant of claim 12, adapted for aiding a golfer in the present play of a golf hole, further comprising:
a database of golf information containing:
data specific to the golfer's golf clubs, including identification of the clubs available to the golfer and the historical average distance the golfer achieves with each club;
GPS coordinates for markers on a presently played golf hole and for the golfer's present position on the golf hole; and
historical data of the golfer's score on a past golf hole, putts on past golf hole, the directional characteristic of drives on a past golf hole, and the distance of drives on a past golf hole;
means analyzing said database content and producing a tip for play on the present hole.

18. The personal electronic assistant of claim 17, further comprising:
an audio speaker; and
means audibly conveying said tip through the audio speaker.
